(19) United States
(12) Patent Application Publication
(10) Pub. No.: US 2025/0142420 A1
(43) Pub. Date: May 1, 2025

(54) GROUP COMMON CELL SWITCHING FOR NETWORK ENERGY SAVING

(71) Applicant: QUALCOMM Incorporated, San Diego, CA (US)

(72) Inventors: Ahmed Attia ABOTABL, San Diego, CA (US); Hung Dinh LY, San Diego, CA (US); Yongjun KWAK, San Diego, CA (US)

(21) Appl. No.: 18/495,214

(22) Filed: Oct. 26, 2023

(51) Int. Cl. H04W 36/00; H04W 36/32

(52) U.S. Cl. CPC H04W 36/0009; H04W 36/32

(57) ABSTRACT

Methods, systems, and devices for wireless communication are described. In some examples, a network entity may establish a connection with two or more user equipments (UEs). The network entity may transmit control signaling to each of the two or more UEs to indicate cell groups and corresponding cell group configurations for each of the two or more UEs. The network entity may detect a change in mobility information associated with the two or more UEs. The network entity may transmit, based on the change in mobility information, a group triggered mobility message that indicates for the two or more UEs to transition from the cell group to one or more second cell groups. The one or more second cell groups may be associated with one or more second cell group configurations that were indicated via the unicast control signaling.

### FIELD OF TECHNOLOGY

The following relates to wireless communication, including group common cell switching for network energy saving.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a network entity may transmit unicast control signaling to a UE to trigger the UE to transition from a first cell group to a second cell group. The UE may transition to communicating via the second cell group in response to the control signaling.

### SUMMARY

The described techniques relate to improved methods, systems, devices, and apparatuses that support group common cell switching for network energy saving. For example, the described techniques provide for groupcast mobility trigger information. In some examples, a network entity may establish a connection with two or more user equipments (UEs) via a serving cell. The network entity may transmit unicast control signaling to each of the two or more UEs to indicate multiple candidate cell groups and corresponding cell group configurations for each of the two or more UEs. The network entity may detect a change in mobility information associated with the two or more UEs. For example, the two or more UEs may change position, speed, direction of motion, or one or more channel metrics at the two or more UEs may drop below a threshold. The network entity may transmit a group triggered mobility message that indicates for the two or more UEs to transition from a current cell group to one or more second cell groups. The one or more second cell groups may be associated with one or more second cell group configurations that were indicated via the unicast control signaling. The network entity may thereby transmit a single message that triggers multiple UEs to transition between cell groups, which may reduce overhead and power consumption by the network.

A method for wireless communication by a network entity is described. The method may include transmitting control signaling that indicates a set of multiple cell groups and a set of multiple cell group configurations, each cell group associated with a respective cell group configuration of the set of multiple cell group configurations, communicating with a first UE of a set of multiple UEs via a first cell group of the set of multiple cell groups in accordance with a first cell group configuration of the set of multiple cell group configurations, and transmitting, via the first cell group, a group triggered mobility message that indicates for the set of multiple UEs to transition from the first cell group to one or more second cell groups of the set of multiple cell groups, the one or more second cell groups associated with one or more second cell group configurations that are different from the first cell group configuration.

A network entity for wireless communication is described. The network entity may include one or more memories storing processor executable code, and one or more processors coupled with the one or more memories. The one or more processors may individually or collectively operable to execute the code to cause the network entity to transmit control signaling that indicates a set of multiple cell groups and a set of multiple cell group configurations, each cell group associated with a respective cell group configuration of the set of multiple cell group configurations, communicate with a first UE of a set of multiple UEs via a first cell group of the set of multiple cell groups in accordance with a first cell group configuration of the set of multiple cell group configurations, and transmit, via the first cell group, a group triggered mobility message that indicates for the set of multiple UEs to transition from the first cell group to one or more second cell groups of the set of multiple cell groups, the one or more second cell groups associated with one or more second cell group configurations that are different from the first cell group configuration.

Another network entity for wireless communication is described. The network entity may include means for transmitting control signaling that indicates a set of multiple cell groups and a set of multiple cell group configurations, each cell group associated with a respective cell group configuration of the set of multiple cell group configurations, means for communicating with a first UE of a set of multiple UEs via a first cell group of the set of multiple cell groups in accordance with a first cell group configuration of the set of multiple cell group configurations, and means for transmitting, via the first cell group, a group triggered mobility message that indicates for the set of multiple UEs to transition from the first cell group to one or more second cell groups of the set of multiple cell groups, the one or more second cell groups associated with one or more second cell group configurations that are different from the first cell group configuration.

A non-transitory computer-readable medium storing code for wireless communication is described. The code may include instructions executable by a processor to transmit control signaling that indicates a set of multiple cell groups and a set of multiple cell group configurations, each cell group associated with a respective cell group configuration of the set of multiple cell group configurations, communicate with a first UE of a set of multiple UEs via a first cell group of the set of multiple cell groups in accordance with a first cell group configuration of the set of multiple cell group configurations, and transmit, via the first cell group, a group triggered mobility message that indicates for the set of multiple UEs to transition from the first cell group to one or more second cell groups of the set of multiple cell groups, the one or more second cell groups associated with one or more second cell group configurations that are different from the first cell group configuration.

In some examples of the method, network entities, and non-transitory computer-readable medium described herein, transmitting the group triggered mobility message may include operations, features, means, or instructions for transmitting, via the group triggered mobility message, an indication for the set of multiple UEs to transition from the first cell group to a single candidate cell group of the set of multiple cell groups.

In some examples of the method, network entities, and non-transitory computer-readable medium described herein, transmitting the group triggered mobility message may include operations, features, means, or instructions for transmitting, via the group triggered mobility message, one or more indexes associated with the one or more second cell groups from among the set of multiple cell groups, where each index of the one or more indexes indicates a respective candidate cell group for a respective UE of the set of multiple UEs.

In some examples of the method, network entities, and non-transitory computer-readable medium described herein, transmitting the group triggered mobility message may include operations, features, means, or instructions for transmitting, via the group triggered mobility message, a first index that indicates a subset of candidate cell groups including the one or more second cell groups, and a second index that indicates a first candidate cell group from among the subset of candidate cell groups.

In some examples of the method, network entities, and non-transitory computer-readable medium described herein, the first index and the second index may be associated with the set of multiple UEs.

In some examples of the method, network entities, and non-transitory computer-readable medium described herein, the first index indicates the subset of candidate cell groups for the set of multiple UEs and the second index indicates the first candidate cell group for the first UE.

In some examples of the method, network entities, and non-transitory computer-readable medium described herein, transmitting the group triggered mobility message may include operations, features, means, or instructions for transmitting, via the group triggered mobility message, a first set of one or more parameters that may be common to the set of multiple UEs and a second set of one or more parameters that may be specific to the first UE.

In some examples of the method, network entities, and non-transitory computer-readable medium described herein, the first set of one or more parameters includes a bandwidth part (BWP) identifier (ID) associated with the one or more second cell groups, a subset of one or more candidate cell groups from among the set of multiple cell groups, a transmission configuration indication (TCI) state indication associated with the one or more second cell groups, a downlink indication associated with the one or more second cell groups, an uplink indication associated with the one or more second cell groups, or any combination thereof.

In some examples of the method, network entities, and non-transitory computer-readable medium described herein, the second set of one or more parameters indicates at least one cell group configuration of the set of multiple cell group configurations associated with the one or more second cell groups, a TCI state indication associated with the one or more second cell groups, a timing advance value associated with the one or more second cell groups, or any combination thereof.

In some examples of the method, network entities, and non-transitory computer-readable medium described herein, transmitting the control signaling may include operations, features, means, or instructions for transmitting, via the control signaling, an indication of one or more bit locations within the group triggered mobility message associated with a respective UE of the set of multiple UEs.

In some examples of the method, network entities, and non-transitory computer-readable medium described herein, the one or more bit locations include at least a first bit location associated with the first set of one or more parameters that may be common to the set of multiple UEs.

In some examples of the method, network entities, and non-transitory computer-readable medium described herein, the one or more bit locations include at least a first bit location associated with the second set of one or more parameters that may be specific to the first UE.

In some examples of the method, network entities, and non-transitory computer-readable medium described herein, transmitting the group triggered mobility message may include operations, features, means, or instructions for transmitting the group triggered mobility message that may be a group downlink control information (DCI) message that indicates for the set of multiple UEs to transition from the first cell group to the one or more second cell groups.

In some examples of the method, network entities, and non-transitory computer-readable medium described herein, transmitting the group triggered mobility message may include operations, features, means, or instructions for transmitting the group triggered mobility message that may be a group medium access control-control element (MAC-CE) message that indicates for the set of multiple UEs to transition from the first cell group to the one or more second cell groups.

In some examples of the method, network entities, and non-transitory computer-readable medium described herein, transmitting the control signaling may include operations, features, means, or instructions for transmitting, to each UE of the set of multiple UEs, a respective unicast radio resource control (RRC) message that indicates the set of multiple cell groups and the set of multiple cell group configurations.

In some examples of the method, network entities, and non-transitory computer-readable medium described herein, transmitting the group triggered mobility message may include operations, features, means, or instructions for transmitting a group layer one mobility message or a group layer two mobility message.

A method for wireless communication by a UE is described. The method may include receiving control signaling that indicates a set of multiple cell groups and a set of multiple cell group configurations, each cell group associated with a respective cell group configuration of the set of multiple cell group configurations, communicating via a first cell group of the set of multiple cell groups in accordance with a first cell group configuration of the set of multiple cell group configurations, and receiving, via the first cell group, a group triggered mobility message that indicates for the UE and one or more second UEs to transition from the first cell group to one or more second cell groups of the set of multiple cell groups, the one or more second cell groups associated with one or more second cell group configurations that are different than the first cell group configuration.

A UE for wireless communication is described. The UE may include one or more memories storing processor executable code, and one or more processors coupled with the one or more memories. The one or more processors may individually or collectively operable to execute the code to cause the UE to receive control signaling that indicates a set of multiple cell groups and a set of multiple cell group configurations, each cell group associated with a respective cell group configuration of the set of multiple cell group configurations, communicate via a first cell group of the set of multiple cell groups in accordance with a first cell group configuration of the set of multiple cell group configurations, and receive, via the first cell group, a group triggered mobility message that indicates for the UE and one or more second UEs to transition from the first cell group to one or more second cell groups of the set of multiple cell groups, the one or more second cell groups associated with one or more second cell group configurations that are different than the first cell group configuration.

Another UE for wireless communication is described. The UE may include means for receiving control signaling that indicates a set of multiple cell groups and a set of multiple cell group configurations, each cell group associated with a respective cell group configuration of the set of multiple cell group configurations, means for communicating via a first cell group of the set of multiple cell groups in accordance with a first cell group configuration of the set of multiple cell group configurations, and means for receiving, via the first cell group, a group triggered mobility message that indicates for the UE and one or more second UEs to transition from the first cell group to one or more second cell groups of the set of multiple cell groups, the one or more second cell groups associated with one or more second cell group configurations that are different than the first cell group configuration.

A non-transitory computer-readable medium storing code for wireless communication is described. The code may include instructions executable by a processor to receive control signaling that indicates a set of multiple cell groups and a set of multiple cell group configurations, each cell group associated with a respective cell group configuration of the set of multiple cell group configurations, communicate via a first cell group of the set of multiple cell groups in accordance with a first cell group configuration of the set of multiple cell group configurations, and receive, via the first cell group, a group triggered mobility message that indicates for the UE and one or more second UEs to transition from the first cell group to one or more second cell groups of the set of multiple cell groups, the one or more second cell groups associated with one or more second cell group configurations that are different than the first cell group configuration.

In some examples of the method, UEs, and non-transitory computer-readable medium described herein, receiving the group triggered mobility message may include operations, features, means, or instructions for receiving, via the group triggered mobility message, an indication for the UE and the one or more second UEs to transition from the first cell group to a single candidate cell group of the set of multiple cell groups.

In some examples of the method, UEs, and non-transitory computer-readable medium described herein, receiving the group triggered mobility message may include operations, features, means, or instructions for receiving, via the group triggered mobility message, one or more indexes associated with the one or more second cell groups from among the set of multiple cell groups, where each index of the one or more indexes indicates a respective cell group for a respective UE of a group of UEs including the UE and the one or more second UEs.

In some examples of the method, UEs, and non-transitory computer-readable medium described herein, receiving the group triggered mobility message may include operations, features, means, or instructions for receiving, via the group triggered mobility message, a first index that indicates a subset of candidate cell groups including the one or more second cell groups, and a second index that indicates a first candidate cell group from among the subset of candidate cell groups.

In some examples of the method, UEs, and non-transitory computer-readable medium described herein, receiving the group triggered mobility message may include operations, features, means, or instructions for receiving, via the group triggered mobility message, a first set of one or more parameters that may be common to the UE and the one or more second UEs and a second set of one or more parameters that may be specific to the UE.

Some examples of the method, UEs, and non-transitory computer-readable medium described herein may further include operations, features, means, or instructions for receiving, via the control signaling, an indication of one or more bit locations within the group triggered mobility message associated with the UE.

In some examples of the method, UEs, and non-transitory computer-readable medium described herein, the one or more bit locations include at least a first bit location associated with the first set of one or more parameters that may be common to the UE and the one or more second UEs.

In some examples of the method, UEs, and non-transitory computer-readable medium described herein, the one or more bit locations include at least a first bit location associated with the second set of one or more parameters that may be specific to the UE.

In some examples of the method, UEs, and non-transitory computer-readable medium described herein, receiving the group triggered mobility message may include operations, features, means, or instructions for receiving the group triggered mobility message that may be a group DCI message that indicates for the UE and the one or more second UEs to transition from the first cell group to the one or more second cell groups.

In some examples of the method, UEs, and non-transitory computer-readable medium described herein, receiving the group triggered mobility message may include operations, features, means, or instructions for receiving the group triggered mobility message that may be a group MAC-CE message that indicates for the UE and the one or more second UEs to transition from the first cell group to the one or more second cell groups.

Some examples of the method, UEs, and non-transitory computer-readable medium described herein may further include operations, features, means, or instructions for transmitting one or more messages for establishing connectivity with a second cell group of the one or more second cell groups based on the group triggered mobility message.

### BRIEF DESCRIPTION OF THE DRAWINGS

FIGS. 1-3 show examples of wireless communications systems that support group common cell switching for network energy saving in accordance with one or more aspects of the present disclosure.

FIG. 4 shows an example of a process flow that supports group common cell switching for network energy saving in accordance with one or more aspects of the present disclosure.

FIGS. 5 and 6 show block diagrams of devices that support group common cell switching for network energy saving in accordance with one or more aspects of the present disclosure.

FIG. 7 shows a block diagram of a communications manager that supports group common cell switching for network energy saving in accordance with one or more aspects of the present disclosure.

FIG. 8 shows a diagram of a system including a device that supports group common cell switching for network energy saving in accordance with one or more aspects of the present disclosure.

FIGS. 9 and 10 show block diagrams of devices that support group common cell switching for network energy saving in accordance with one or more aspects of the present disclosure.

FIG. 11 shows a block diagram of a communications manager that supports group common cell switching for network energy saving in accordance with one or more aspects of the present disclosure.

FIG. 12 shows a diagram of a system including a device that supports group common cell switching for network energy saving in accordance with one or more aspects of the present disclosure.

FIGS. 13 through 17 show flowcharts illustrating methods that support group common cell switching for network energy saving in accordance with one or more aspects of the present disclosure.

### DETAILED DESCRIPTION

In some wireless communications systems, a network entity may transmit control signaling, such as radio resource control (RRC) signaling, to a user equipment (UE) to indicate a set of candidate cell groups and corresponding cell group configurations for the UE. A cell group configuration may indicate one or more cells, frequency bands, network entities, or other parameters associated with a connection between the UE and the network using a corresponding cell group. The network entity may transmit separate RRC signaling to each UE in a coverage area to indicate respective candidate cell groups and corresponding configurations. In some systems, the network entity may transmit lower layer signaling, such as a medium access control-control element (MAC-CE) to trigger a UE to switch between cell groups. The MAC-CE may be a unicast message transmitted per UE and may convey switching information for the UE. Techniques for reducing network energy consumption for triggering cell group switches may be beneficial.

As described herein, a network entity may reduce energy consumption and overhead by transmitting a group triggered mobility message to multiple UEs at the same time. The network entity may transmit a trigger and information for switching between cell groups to multiple UEs via a groupcast message (referred to as a group triggered mobility message), which may provide for reduced energy consumption and reduced overhead as compared with systems in which the network entity transmits multiple separate unicast messages. The group triggered mobility message may be a groupcast lower-layer (e.g., Layer 1 or Layer 2) mobility message. For example, the network entity may transmit a groupcast MAC-CE or a groupcast downlink control information (DCI) message to multiple UEs. The network entity may transmit the group triggered mobility message to a group of one or more UEs that share at least some similar mobility metrics. For example, the group of UEs may be shared by a same user (e.g., a phone, smart watch, tablet, etc.), or may be within a same vehicle or otherwise moving in a same direction at a same speed, among other examples.

The mobility message may indicate a single cell group for all of the UEs to switch to or different cell groups per UE, or a combination. For example, the group triggered mobility message may include a single index to a single target cell group or various indexes to different target cell groups for different UEs. The mobility message may include one or more switching parameters that are common to the multiple UEs and one or more UE-specific switching parameters. The common parameters may include, for example, a bandwidth part (BWP) identifier (ID) associated with a target cell group, a subset of candidate cell groups, a transmission configuration indication (TCI) state indication associated with the target cell group, a downlink or uplink indication associated with the target cell group, or any combination thereof. The UE-specific parameters may include, for example, a cell group configuration, a TCI state indication, a timing advance (TA) value associated with the target cell group, or any combination thereof. The network entity may thereby reduce a quantity of mobility messages that are transmitted to reduce energy consumption and overhead.

Aspects of the disclosure are initially described in the context of wireless communications systems. Additional aspects of the disclosure are described with reference to a process flow. Aspects of the disclosure are further illustrated by and described with reference to apparatus diagrams, system diagrams, and flowcharts that relate to group common cell switching for network energy saving.

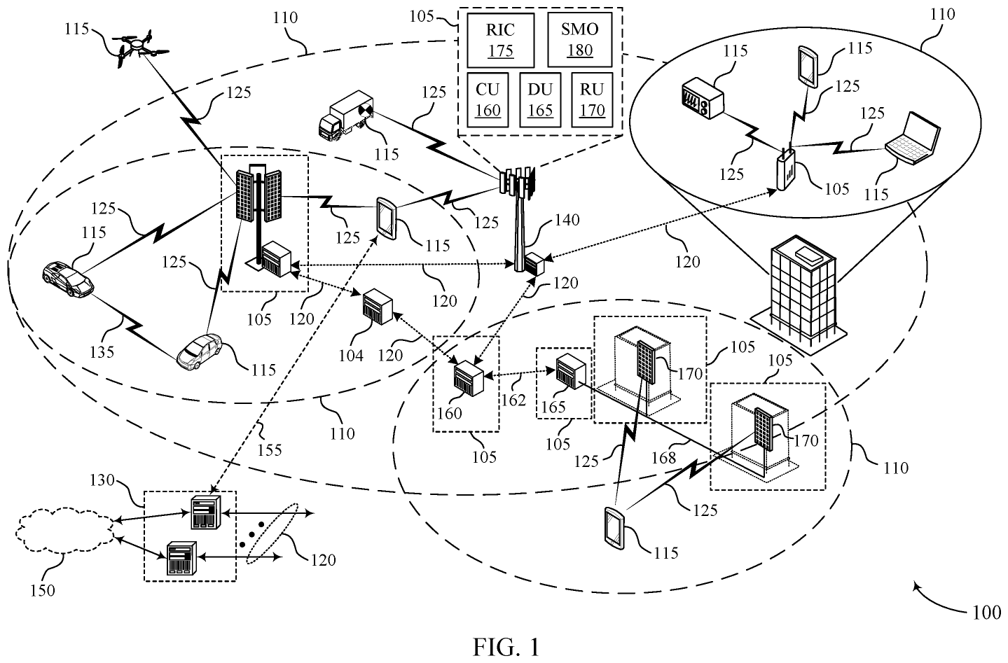

FIG. 1 shows an example of a wireless communications system 100 that supports group common cell switching for network energy saving in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support group common cell switching for network energy saving as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some aspects of the wireless communications system 100 may support reduced network energy consumption. A cost of network energy consumption to run a cellular network may be relatively high. A large portion of the network energy consumption may come from the RAN. Techniques for network energy savings may provide for increased adoption and expansion of cellular networks. In some examples, the network entities 105 may support one or more network-side energy savings techniques (e.g., a base station energy consumption model). For example, the network may consider one or more factors associated with relative energy consumption for uplink and downlink, such as an efficiency of a power amplifier (PA) at a network entity 105, a quantity of transmit RUs, a load at a network entity 105, or the like. Additionally, or alternatively, the network may consider sleep states and associated transition times, one or more reference parameters or configurations, or any combination thereof for network energy savings. The evaluation methodology may target evaluation of system-level network energy consumption and energy savings gains, as well as assessing and/or balancing impact to network performance and user performance (e.g., spectral efficiency, capacity, user perceived throughput (UPT), latency, handover performance, call drop rate, initial access performance, service level agreement (SLA) assurance related key performance indicators (KPIs), energy efficiency, UE power consumption, UE complexity, or the like). The evaluation methodology may consider multiple such KPIs and may reuse existing KPIs, in some examples, or develop new KPIs as needed.

In some examples, techniques for achieving improved network energy savings in terms of both transmission and reception between a network entity 105 and a UE 115 may be beneficial. As such, some techniques to improve network energy savings may be explored. Such techniques may include, among other examples, techniques for achieving more efficient operation dynamically and/or semi-statically, techniques for relatively fine granularity adaptation of transmissions and receptions in time, frequency, spatial, and power domains, techniques for support and feedback from a UE 115, techniques for UE assistance information, techniques for information exchange and coordination over network interfaces, or any combination thereof.

In some examples, a network entity 105 may transmit UE-specific signaling for UE mobility. The signaling may be configured via lower layers (e.g., Layer 1 and/or Layer 2), which may be referred to as lower-layer triggered mobility (LTM), in some examples. A cell group configuration may indicate one or more frequency bands, network entities 105, or other parameters associated with a connection between the UE 115 and the network using a corresponding cell group. The network entity 105 may configure the UE 115 with multiple cell group configurations. The multiple cell group configurations may be indicated via control signaling, such as an RRC message, or some other configuration. The multiple cell group configurations may be indicated via separate configuration parameters within the control signaling. Additionally, or alternatively, a reference configuration may be indicated via the control signaling along with one or more delta configurations. The delta configurations may indicate offsets from the reference configuration to other cell group configurations. The UE 115 may store the reference configuration as a separate configuration and the reference configuration may be managed separately from the other delta configurations.

The network entity 105 may trigger the UE 115 to switch from one cell group to another cell group by transmitting lower layer signaling, such as a MAC-CE, or some other type of lower layer signaling, to the UE 115 to indicate one of the previously configured cell group configurations to which the UE 115 is to transition. The MAC-CE may carry LTM-related information to trigger a cell switch. The lower layer signaling may be referred to as an L1/L2 mobility trigger, in some examples. The L1/L2 mobility trigger may include at least one candidate configuration index, which may be an index to a target cell group configuration to which the UE 115 is to transition. The L1/L2 mobility trigger may additionally, or alternatively, include other candidate information, including a TCI state, a secondary cell (SCell) activation or deactivation, other information, or any combination thereof.

The L1/L2 mobility switch may be utilized for both RACH-based procedures (e.g., contention-free random access (CFRA) or contention-based random access (CBRA)) and RACH-less procedures. If the UE 115 does not acquire TA information during the cell switch, the procedure may be RACH-less. If the UE 115 performs a RACH-based procedure, the RACH resources for CFRA for a dynamic switch may be provided via an RRC configuration. The LTM switch by the UE 115 may be supervised by a timer. The arrival of the UE 115 in the target cell may be indicated to the network via signaling (e.g., a UE presence indication, or some other type of indication).

Techniques described herein provide for network-side energy savings by reducing UE-specific signaling in scenarios in which two or more UEs 115 share similar mobility characteristics. For example, the two or more UEs 115 may belong to a same user (e.g., a phone, smart watch, augmented reality (AR) set, or the like), or the two or more UEs 115 may share similar mobility characteristics (e.g., a group of UEs 115 on a bus, or other similar scenarios). In such scenarios, a group common indication for lower layer mobility may provide for reduced energy consumption while maintaining communication reliability and throughput.

As described herein, a network entity 105 may transmit a trigger and information for switching between cell groups to multiple UEs 115 via a groupcast message, which may provide for reduced energy consumption and reduced overhead. The network entity 105 may transmit unicast RRC signaling to each UE 115 in a coverage area of the network entity 105 to indicate candidate cell groups. The network entity 105 may reduce energy consumption by indicating switching information via a groupcast lower-layer (e.g., L1 or L2) mobility message. For example, the network entity 105 may transmit a groupcast MAC-CE or a groupcast DCI message to multiple UEs 115. The mobility message may include one or more switching parameters that are common to the multiple UEs 115 and one or more UE-specific switching parameters. The mobility message may indicate a single cell group for all of the UEs 115 to switch to or different cell groups per UE 115, or a combination. The network entity 105 may thereby reduce a quantity of mobility messages that are transmitted to reduce energy consumption and overhead.

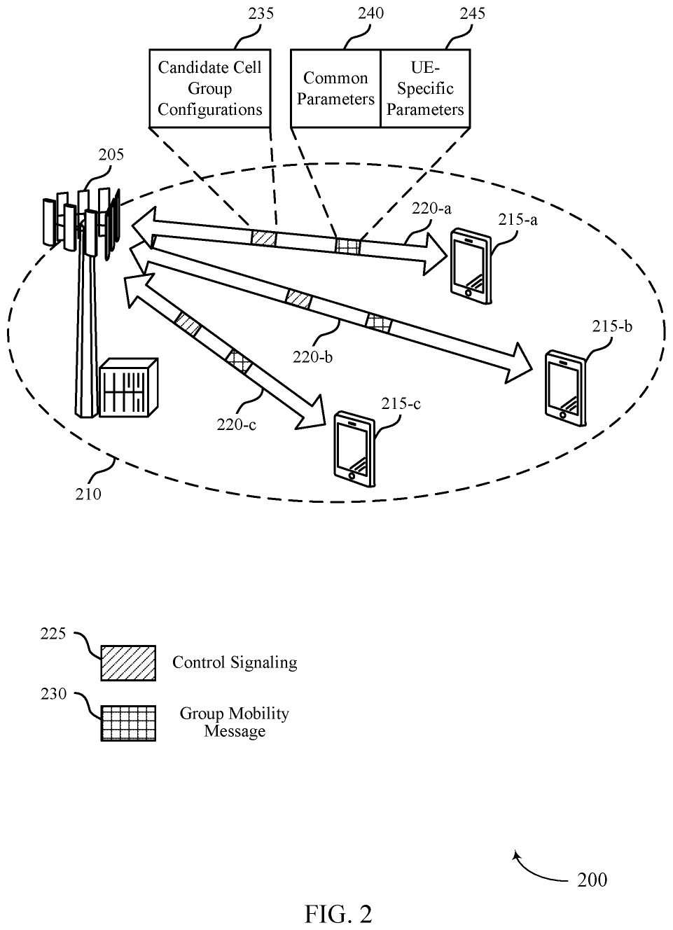

FIG. 2 shows an example of a wireless communications system 200 that supports group common cell switching for network energy saving in accordance with one or more aspects of the present disclosure. The wireless communications system 200 may include network entity 205 and UEs 215-a, 215-b, and 215-c (among other potential UEs 215), which may represent examples of a network entity 105 and a UE 115 as described with reference to FIG. 1. The network entity 205 may communicate with the UEs 215-a, 215-b, and 215-c within a geographic coverage area 210 and via communication links 220-a, 220-b, and 220-c, respectively.

The network entity 205 may establish communications with each of the UEs 215-a, 215-b, and 215-c via the respective communication links 220 (e.g., Uu links). The network entity 205 may transmit unicast control signaling 225 to each of the UEs 215-a, 215-b, and 215-c. For example, the network entity 205 may transmit the unicast control signaling 225 to the UE 215-a via the communication link 220-a, and the network entity 205 may transmit separate unicast control signaling 225 to the UE 215-b via the communication link 220-b. The unicast control signaling 225 may represent an example of an RRC message, or some other control signaling intended for a single UE 215.

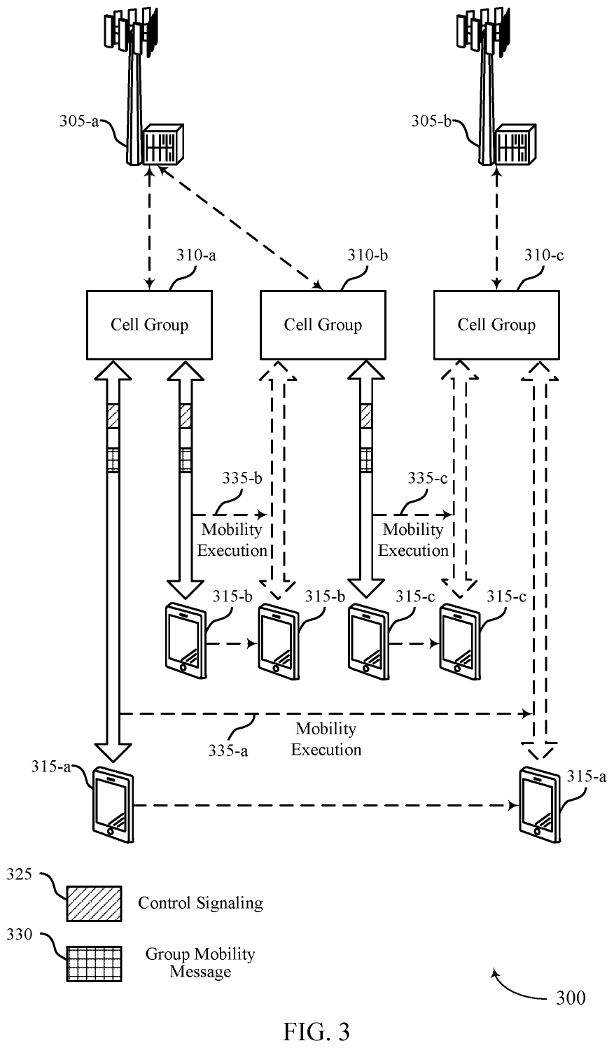

The control signaling 225 for a given UE 215 may indicate one or more cell groups and a corresponding set of one or more candidate cell group configurations 235 for the UE 215. Each cell group may be associated with a respective cell group configuration. The cell group configuration may indicate information related to the cell group, such as a corresponding network entity 105, frequency range, TCI state, or the like. The candidate cell group configurations 235 may be the same for each of the UEs 215-a, 215-b, and 215-c, in some examples. For example, each of the UEs 215-a, 215-b, and 215-c may receive separate unicast control signaling 225 that indicates a same three candidate cell group configurations 235. Additionally, or alternatively, the control signaling 225 for the UE 215-a may indicate different candidate cell group configurations 235 than the control signaling 225 for the UE 215-b. In some examples, at least one candidate cell group configuration may be common to two or more of the UEs 215. The network entity 205 may communicate with each of the UEs 215 based on a previously established connection within the geographic coverage area 210. The UEs 215-a, 215-b, 215-c may be within a coverage area of the network entity 205 and may communicate via one or more cell groups, which may be one of the cell groups indicated via the control signaling 225. In some examples, the geographic coverage area 210 may represent a coverage area of the network entity 205 and may be associated with a serving cell for the UEs 215-a, 215-b, and 215-c. The various cell groups indicated by the network entity 205 may include cells within the serving cell (e.g., served by the network entity 205), cells served by a different network entity 205, or both, as described in further detail elsewhere herein, including with reference to FIG. 3.

After some time period of communicating with the UEs 215, the network entity 205 may detect a condition that indicates a change in cell groups for one or more of the UEs 215. For example, the network entity 205 may detect (e.g., based on signaling from the UEs 215 or other channel measurements) that the UEs 215 have changed locations, or that a channel quality at the UEs 215 is decreasing, or some other condition. In some examples, each UE 215 may transmit channel state information (CSI) or other channel measurement reports to the network entity 205, and the network entity 205 may determine the condition based on the signaling. The network entity 205 may transmit a group common mobility message 230 to each of the UEs 215-a, 215-b, and 215-c based on detecting the condition. The group mobility message 230 may be a group common DCI message, a groupcast MAC-CE, some other type of lower layer group-based signaling, or any combination thereof. The network entity 205 may thereby transmit a single message that conveys mobility trigger information for multiple UEs 215, which may reduce overhead and energy consumption by the network entity 205.

The network entity 205 may determine to combine the UEs 215-a, 215-b, and 215-c into a same group for purposes of the group mobility message 230 based on one or more measurements or other communication parameters associated with the UEs 215. In some examples, the network entity 205 may receive trajectory information or other information associated with a mobility of each of the UEs 215, and the network entity 205 may determine to combine UEs 215 that are moving in a same direction or are associated with a same or similar location, or both. Additionally, or alternatively, if the network entity 205 can communicate with multiple UEs 215 using a same or similar beam, the network entity 205 may determine that the UEs 215 may be combined into a group.

The network entity 205 may configure the UEs 215 to monitor for a group common DCI with a certain radio network temporary identifier (RNTI) (e.g., a group RNTI (G-RNTI)). If more than one UE 215 receives an indication to monitor for a group common DCI, the UEs 215 may thereby receive the same group common signaling. In some examples, the network entity 205 may indicate, to each UE 215, a respective portion or set of fields in the DCI for the UE 215 to monitor. The network entity 205 may ensure that the transmission beam, MCS, transmission power, and one or more other transmission parameters associated with the group mobility message 230 are sufficient for reliable reception by each UE 215 in the group, such that all of the UEs 215 in the group may receive and decode the group common signaling.

The group mobility message 230 may include cell switching information and a switching trigger. If the group mobility message 230 is a MAC-CE, the network entity 205 may transmit a DCI message that schedules a groupcast physical downlink shared channel (PDSCH), and the PDSCH may carry the payload of the MAC-CE. The groupcast MAC-CE may carry cell switching information and a cell switching trigger. If the group mobility message 230 is a group common DCI message, the DCI message may carry an index or configured (e.g., pre-configured) cell switching information as well as the cell switching trigger. In some examples, a combination of a MAC-CE and a DCI may be used to convey the switching information and trigger. For example, the MAC-CE may convey the switching information via a relatively large payload, and the DCI may convey the switching trigger, or any other combination.

The group mobility message 230 may include two or more parts (e.g., either in a same indication or two separate indications). One part may include common parameters 240 and the other part may include UE-specific parameters 245. The common parameters 240 may be parameters that are used by each UE 215 that receives the group mobility message 230. By sharing at least some parameters across UEs 215, the network entity 205 may reduce an overhead associated with the group mobility message 230. For example, the size of the group mobility message 230 may be reduced as compared The common parameters may be, for example, a BWP ID, a partition of a candidate configuration identity (e.g., narrow down a set of candidate cell group configurations for the UEs), a joint or separate TCI state indication, a downlink or uplink indication, or any combination thereof. By indicating a common BWP ID, the network entity 205 may align all UEs within a same set of frequency resources (e.g., frequency band), which may improve network energy savings. The downlink and uplink indications may indicate whether the group of UEs 215 is to expect downlink communications, uplink communications, or both, and any TDD and/or FDD patterns associated with such communications. In some examples, the TCI state indication, the downlink/uplink indication, or both may be common to the UEs 215 or UE specific, depending on UE capabilities and other UE parameters.

The UE-specific parameters 245 may be parameters that are unique to certain UEs 215. The UE-specific parameters 245 may include, for example, a candidate configuration identity (e.g., a candidate cell group configuration), a TCI state ID, a TA value, one or more other parameters, or any combination thereof. In some examples, the group mobility message 230 may include separate portions or subsets of fields each associated with a respective UE 215. The network entity 205 may convey UE-specific parameters 245 via the separate portions. For example, the UE 215-a may be configured to monitor a first set of fields within the group mobility message 230. The first set of fields may include parameters specific to the UE 215-a. The UE 215-b may be configured to monitor a second set of fields within the group mobility message 230. The second set of fields may include parameters specific to the UE 215-b. The UEs 215 may additionally, or alternatively, be configured to monitor a same set of fields that convey the common parameters 240. The UEs 215 may thereby receive the common parameters 240, the UE-specific parameters 245, or both via respective portions of the same group mobility message 230.

The network entity 205 described herein may thereby support UE-specific candidate cell group configurations 235 in combination with group-common mobility signaling. That is, the network entity 205 may transmit a group mobility message to a group of UEs 215 that includes switching parameters and a switching trigger for the UEs 215 to switch between cell group configurations. By transmitting the mobility indication via group signaling, the network entity 205 may reduce overhead, which may support improved network energy savings, among other examples. Techniques for indicating which cell group configuration for the group of UEs 215 to switch to are described in further detail elsewhere herein, including with reference to FIG. 3.

FIG. 3 shows an example of a wireless communications system 300 that supports group common cell switching for network energy saving in accordance with one or more aspects of the present disclosure. The wireless communications system 300 may implement or be implemented by aspects of the wireless communications systems 100 and 200, as described with reference to FIGS. 1 and 2. For example, the wireless communications system 300 includes network entities 305-a and 305-b, which may communicate with any of a set of UEs 315-a, 315-b, and 315-c via one or more cell groups 310-a, 310-b, and 310-c. The network entities 305, UEs 315, and cell groups 310 may represent examples of corresponding devices and cell groups as described with reference to FIGS. 1-3.

A cell group 310 may represent an example of a group of one or more cells via which wireless devices may communicate with a network. The cells may include, for example, a primary cell (PCell), a master cell, an SCell, some other types of cells, or any combination thereof). The cell groups 310-a, 310-b, and 310-c may be associated with (e.g., managed by, include) same or different network entities 305. In the example of FIG. 3, the network entity 305-a may support communications via the cell group 310-a and the cell group 310-b and the network entity 305-b may support communications via the cell group 310-c. The cell group 310-a and the cell group 310-b may represent examples of different groups of PCells and SCells, for example, within a same serving cell, where the network entity 305-a may be associated with the serving cell.

The network entity 305-a, the network entity 305-b, or both may transmit control signaling 325 to one or more UEs 315 that indicates a set of candidate cell group configurations. The control signaling 325 may represent an example of the control signaling 225 described with reference to FIG. 2. The network entity 305-a, for example, may be in communication with the UEs 315-a, 315-b, and 315-c via the cell groups 310-a and 310-b (e.g., and a corresponding serving cell). The network entity 305-a may transmit the control signaling 325 to each of the UEs 315-a, 315-b, and 315-c separately via the established connections accordingly. Each of the UEs 315 may be configured with a respective set of one or more candidate cell group configurations. In some examples, one or more of the candidate cell group configurations may be the same for the UEs 315. For example, the UE 315-a may be configured with a first set of candidate cell group configurations including the cell group 310-a, the cell group 310-c, and one or more other cell groups 310. The UE 315-b may be configured with a second set of candidate cell group configurations including the cell group 310-b and the cell group 310-c. The UE 315-c may also be configured with the second set of candidate cell group configurations, in some examples.

After indicating the set of candidate cell group configurations, the network entity 305-a may dynamically transmit a mobility indication that triggers the UEs 315 to switch between cell groups 310 based on one or more communication parameters. The network entity 305-a may determine which cell groups 310 for each UE 315 to switch to based on traffic conditions associated with the UE 315, a load associated with the cell groups 310, one or more other communication parameters, or any combination thereof.

As described herein, the network entity 305-a may transmit a group mobility message 330 to multiple UEs 315 to reduce overhead (e.g., instead of transmitting separate mobility indications). The dynamic group mobility message 330 may indicate (e.g., point to) configurations for candidate cell groups 310 from among a set of previously configured candidate cell group configurations. In some examples, the group mobility message 330 may indicate a same candidate cell group 310 for all UEs 315 that receive the group mobility message 330, or the group mobility message 330 may indicate a different candidate cell group 310 for one or more of the UEs 315.

In some examples, the network entity 305-a may determine that UE 315-a and UE 315-b may be included in a same group. For example, the UEs 315-a and 315-b may be associated with a similar beam, TCI state, mobility parameters, or any combination thereof. The network entity 305-a may transmit the group mobility message 330 to both of the UEs 315-a and 315-b. The group mobility message 330 may be a MAC-CE, a DCI, or both, and may include parameters common to both of the UEs 315-a and 315-b, parameters specific to each of the UEs 315-a and 315-b, or both, as described with reference to FIG. 2. In this example, the group mobility message 330 may include a candidate cell group 310 for each UE 315 in the group. For example, the group mobility message 330 may indicate that the cell group 310-c is a candidate cell group for the UE 315-a and the cell group 310-b is a candidate cell group for the UE 315-b. The network entity 305-a may determine that the UEs 315-a and 315-b are to transition to different cell groups 310 and may indicate separate target cell group configurations accordingly. The pointers to the separate target cell group configurations may be conveyed via one or more UE-specific parameters in the group mobility message 330. For example, the pointer to the cell group 310-c may be conveyed via a portion of the group mobility message 330 that is intended for the UE 315-a and the pointer to the cell group 310-b may be conveyed via a portion of the group mobility message 330 that is intended for the UE 315-b.

The UE 315-a may thereby perform the mobility execution 335-a to switch from the cell group 310-a to the cell group 310-c in response to the group mobility message 330. The mobility execution 335-a may be associated with a switch in serving cells and corresponding network entities 305-b. For example, the UE 315-a may establish a new connection with the network entity 305-b via a serving cell associated with the cell group 310-c (e.g., a handover procedure). The UE 315-b may perform the mobility execution 335-b to switch from the cell group 310-a to the cell group 310-b in response to the group mobility message 330. The mobility execution 335-b may include a switch between cell groups 310 within a same serving cell. That is, the UE 315-b may remain connected to the network entity 305-a, but one or more different cells may be activated and/or deactivated. The mobility executions 335 may be performed in accordance with one or more switching parameters indicated via the group mobility message 330. The switching parameters may include parameters common to both of the UEs 315-a and 315-b, parameters specific to each of the UEs 315-a and 315-b, or both, as described with reference to FIG. 2.

In some other examples, the network entity 305-a may transmit a group mobility message that includes a same candidate cell index for all UEs 315 in the group. For example, the network entity 305-a may determine that the UE 315-a and the UE 315-c may be included in a same group. For example, the UEs 315-a and 315-c may be associated with a similar beam, TCI state, mobility parameters, or any combination thereof. The network entity 305-a may transmit the group mobility message 330 to both of the UEs 315-a and 315-c. The group mobility message 330 may be a MAC-CE, a DCI, or both, and may include parameters common to both of the UEs 315-a and 315-c, parameters specific to each of the UEs 315-a and 315-c, or both, as described with reference to FIG. 2. In this example, the group mobility message 330 may indicate a single candidate cell group 310 for both of the UEs 315-a and 315-c. That is, the group mobility message 330 may include an index to the candidate cell group 310-c in a common portion of the mobility message 330. Both of the UEs 315-a and 315-c may decode the common portion and identify the candidate cell group 310-c.

The UE 315-a may thereby perform the mobility execution 335-a to switch from the cell group 310-a to the cell group 310-c in response to the group mobility message 330. The UE 315-c may perform the mobility execution 335-c to switch from the cell group 310-b to the cell group 310-c in response to the group mobility message 330. The mobility executions 335 may be performed in accordance with one or more switching parameters indicated via the group mobility message 330. The switching parameters may include parameters common to both of the UEs 315-a and 315-c, parameters specific to each of the UEs 315-a and 315-c, or both, as described with reference to FIG. 2.

In some other examples, the group mobility message 330 may include two indexes. A first index may include an index to select from a sub-group of cell group configurations, and a second index may indicate a candidate cell group configuration in the sub-group. The first index and the second index may be common to all UEs 315 in a group, or the first index may be common to the UEs 315 and the second index may be UE-specific. With reference to FIG. 3 as an example, if the UEs 315-a and 315-c are included in a group and receive the same group mobility message 330, the group mobility message 330 may include a first index that is common to both of the UEs 315-a and 315-c. The first index may select a set of two or more candidate cell groups 310 (e.g., a sub-group) from among the multiple candidate cell groups that are configured via the control signaling 325. The group mobility message 330 may additionally include a second index that is common to both of the UEs 315-a and 315-c. The second index may point to a single candidate cell group 310-c from among the set of two or more candidate cell groups 310 indicated by the first index. The UEs 315-a and 315-c may thereby determine to switch to the cell group 310-c.

In another example, if all of the UEs 315-a, 315-b, and 315-c are in a group and receive the same group mobility message 330, the first index may be common and the second index may be UE-specific. For example, the first index may indicate a set of two or more candidate cell groups 310 including at least the cell group 310-b and the cell group 310-c. The first index may be transmitted via a common portion of the group mobility message 330 that each of the UEs 315-a, 315-b, and 315-c may decode. The network entity 305-a may transmit three separate second indexes for each of the UEs 315-a, 315-b, and 315-c. Each second index may select a single candidate cell group 310 from among the set of two or more cell groups indicated via the first index. For example, a portion of the group mobility message 330 associated with the UE 315-a may indicate a second index to the cell group 310-c, a portion of the group mobility message 330 associated with the UE 315-b may indicate a second index to the cell group 310-b, and a portion of the group mobility message 330 associated with the UE 315-c may indicate a second index to the cell group 310-c. The UEs 315 may perform the respective mobility executions 335 to transition to the corresponding cell groups 310 based on the mobility message.

The techniques described herein provide for a network entity 305 to signal a cell switch trigger as well as switching information to multiple UEs 315 via a common message. By indicating the cell group trigger and switching information via the common message instead of separate unicast messages, the network may reduce overhead and energy consumption. It is to be understood that any network entity 305 may transmit a group mobility message 330 to any group of two or more UEs 315 that have a connection established with the network entity 305. The group mobility message 330 may indicate one or more cell group configurations for the group of UEs 315 or individual UEs 315 in the group to switch to, along with group-common and/or UE-specific parameters for the switch.

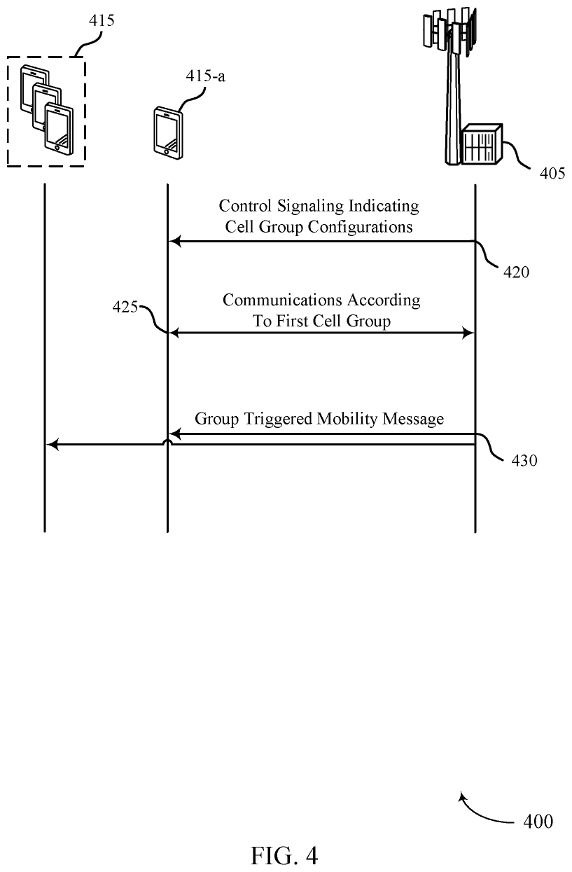

FIG. 4 shows an example of a process flow 400 that supports group common cell switching for network energy saving in accordance with one or more aspects of the present disclosure. The process flow 400 may implement or be implemented by aspects of the wireless communications systems 100, 200, and 300, as described with reference to FIGS. 1-3. For example, the process flow 400 illustrates communications between a network entity 405, a UE 415-a, and one or more other UEs 415, which may represent examples of network entities and UEs as described with reference to FIGS. 1-3. In this example, the network entity 405 may transmit a mobility trigger and corresponding switching information via a groupcast message to the UE 415-a and the one or more other UEs 415.

In the following description of the process flow 400, the operations between the network entity 405 and the UEs 415 may be performed in different orders or at different times. Some operations may also be left out of the process flow 400, or other operations may be added. Although network entity 405 and the UEs 415 are shown performing the operations of the process flow 400, some aspects of some operations may also be performed by one or more other wireless devices.

At 420, the network entity 405 may transmit, to the UE 415-a, control signaling that indicates cell groups and cell group configurations. Each cell group may be associated with a respective cell group configuration, as described with reference to FIGS. 2 and 3. The control signaling may be unicast control signaling. The control signaling may be, for example, RRC signaling, or some other type of control signaling. In some examples, the network entity 405 may transmit separate unicast control messages to each of the other UEs 415. The network entity 405 may thereby configure each UE 415 with a set of candidate cell groups and corresponding cell group configurations. The network entity 405 may transmit the control signaling after establishing a connection with the UE 415-a, periodically, semi-statically, or based on some condition or trigger. The network entity 405 may communicate with the UE 415-a via a serving cell, which may include one or more cell configurations.

At 425, the network entity 405 and the UE 415-a may communicate via a first cell group of the cell groups indicated via the control signaling. The network entity 405 and the UE 415-a may communicate according to a corresponding first cell group configuration (e.g., within the serving cell). The network entity 405 and the UE 415-a may exchange uplink and downlink communications, including data, control messages, reference signals, channel measurements, other types of information, or any combination thereof.

The network entity 405 may additionally, or alternatively, communicate with one or more of the other UEs 415 via the first cell group or any other cell groups associated with the network entity 405. The network entity 405 may communicate with the UEs 415 based on a connection established between the network entity 405 and the UEs 415 within the serving cell.

At 430, the network entity 405 may transmit, via the first cell group, a group triggered mobility message that indicates for the UE 415-a and the one or more other UEs 415 to transition from the first cell group to one or more second cell groups. The network entity 405 may transmit the group triggered mobility message to each of the UEs 415 via groupcast signaling. The group triggered mobility message may be, for example, a groupcast DCI message or a groupcast MAC-CE, or some other type of groupcast signaling. The network entity 405 may transmit the group-triggered mobility message based on identifying a condition associated with the UEs 415. For example, a position, speed, or direction of the UEs 415 may change, one or more channel measurements at the UEs 415 may change, or some other scenario, and the network entity 405 may determine that the UEs 415 are to switch cell groups. In some examples, the network entity 405 may determine the changed conditions based on signaling from the UEs 415, such as CSI reports, UE assistance information, tracking reference signals (TRSs), or other types of signaling.

The group triggered mobility message may include an indication for the UE 415-a and the other UEs 415 to transition from the first cell group to a single candidate cell group. The message may indicate an index of the single candidate cell group. Additionally, or alternatively, the group triggered mobility message may include one or more indexes associated with one or more second cell groups, where each index indicates a respective candidate cell group for a respective UE 415. For example, the group triggered mobility message may include a first index that indicates a first candidate cell group for the UE 415-a and a second index that indicates a second candidate cell group for a second UE 415. In some other examples, the group triggered mobility message may include a first index that indicates a subset of candidate cell groups and a second index that selects one of the cell groups from among the subset. The first and second indexes may be UE-common or UE-specific.

The group triggered mobility message may additionally include switching information and corresponding switching parameters for the UEs 415. The switching parameters may be common to the UE 415-a and the one or more other UEs 415, or the switching parameters may be UE-specific, as described with reference to FIGS. 2 and 3.

The network entity 405 may thereby transmit a single groupcast message to the UE 415-a and the one or more other UEs 415, which may reduce overhead and power consumption as compared with systems in which a network entity transmits separate messages to each of the UEs 415.

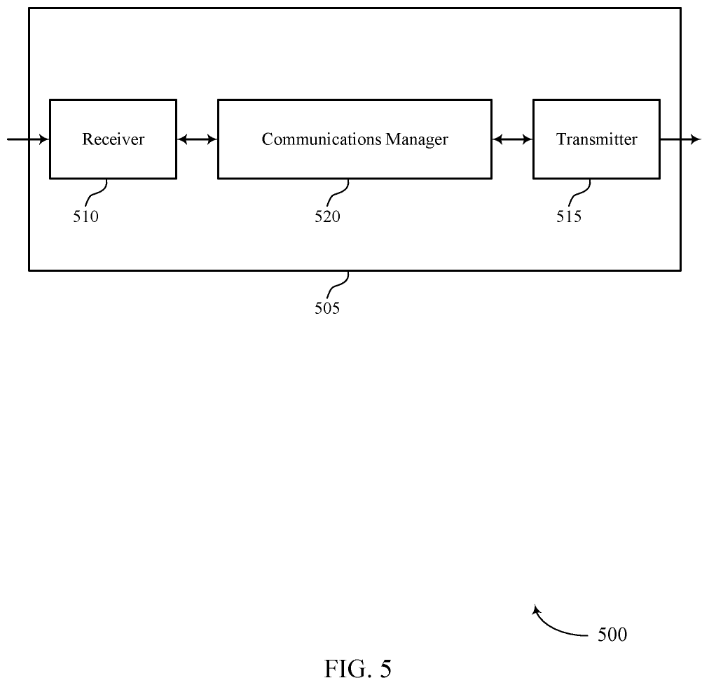

FIG. 5 shows a block diagram 500 of a device 505 that supports group common cell switching for network energy saving in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations thereof or various components thereof may be examples of means for performing various aspects of group common cell switching for network energy saving as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 is capable of, configured to, or operable to support a means for transmitting control signaling that indicates a set of multiple cell groups and a set of multiple cell group configurations, each cell group associated with a respective cell group configuration of the set of multiple cell group configurations. The communications manager 520 is capable of, configured to, or operable to support a means for communicating with a first UE of a set of multiple UEs via a first cell group of the set of multiple cell groups in accordance with a first cell group configuration of the set of multiple cell group configurations. The communications manager 520 is capable of, configured to, or operable to support a means for transmitting, via the first cell group, a group triggered mobility message that indicates for the set of multiple UEs to transition from the first cell group to one or more second cell groups of the set of multiple cell groups, the one or more second cell groups associated with one or more second cell group configurations that are different from the first cell group configuration.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources, among other examples.

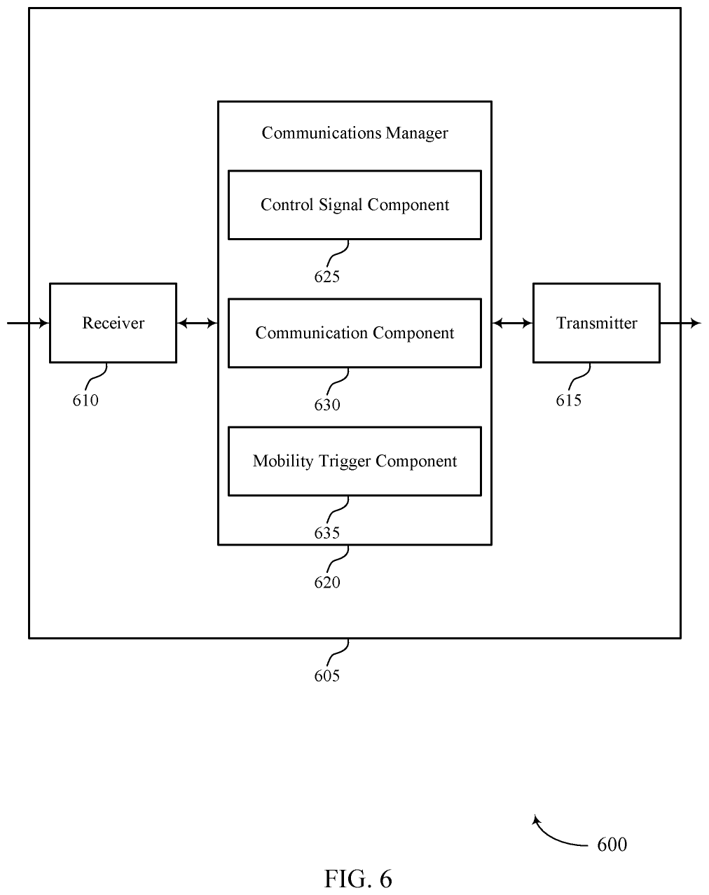

FIG. 6 shows a block diagram 600 of a device 605 that supports group common cell switching for network energy saving in accordance with one or more aspects of the present disclosure. The device 605 may be an example of aspects of a device 505 or a network entity 105 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of group common cell switching for network energy saving as described herein. For example, the communications manager 620 may include a control signal component 625, a communication component 630, a mobility trigger component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The control signal component 625 is capable of, configured to, or operable to support a means for transmitting control signaling that indicates a set of multiple cell groups and a set of multiple cell group configurations, each cell group associated with a respective cell group configuration of the set of multiple cell group configurations. The communication component 630 is capable of, configured to, or operable to support a means for communicating with a first UE of a set of multiple UEs via a first cell group of the set of multiple cell groups in accordance with a first cell group configuration of the set of multiple cell group configurations. The mobility trigger component 635 is capable of, configured to, or operable to support a means for transmitting, via the first cell group, a group triggered mobility message that indicates for the set of multiple UEs to transition from the first cell group to one or more second cell groups of the set of multiple cell groups, the one or more second cell groups associated with one or more second cell group configurations that are different from the first cell group configuration.

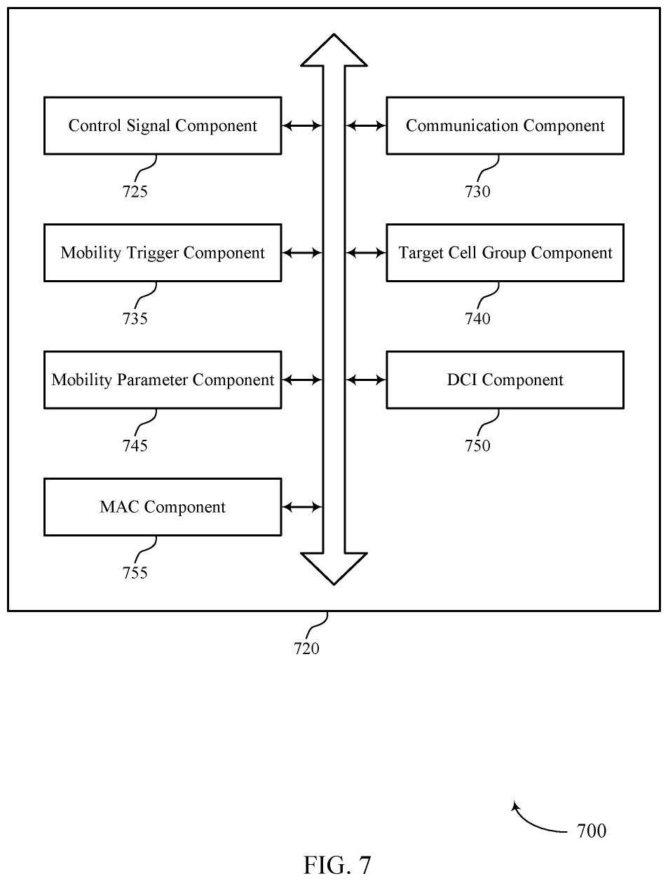

FIG. 7 shows a block diagram 700 of a communications manager 720 that supports group common cell switching for network energy saving in accordance with one or more aspects of the present disclosure. The communications manager 720 may be an example of aspects of a communications manager 520, a communications manager 620, or both, as described herein. The communications manager 720, or various components thereof, may be an example of means for performing various aspects of group common cell switching for network energy saving as described herein. For example, the communications manager 720 may include a control signal component 725, a communication component 730, a mobility trigger component 735, a target cell group component 740, a mobility parameter component 745, a DCI component 750, a MAC component 755, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communication in accordance with examples as disclosed herein. The control signal component 725 is capable of, configured to, or operable to support a means for transmitting control signaling that indicates a set of multiple cell groups and a set of multiple cell group configurations, each cell group associated with a respective cell group configuration of the set of multiple cell group configurations. The communication component 730 is capable of, configured to, or operable to support a means for communicating with a first UE of a set of multiple UEs via a first cell group of the set of multiple cell groups in accordance with a first cell group configuration of the set of multiple cell group configurations. The mobility trigger component 735 is capable of, configured to, or operable to support a means for transmitting, via the first cell group, a group triggered mobility message that indicates for the set of multiple UEs to transition from the first cell group to one or more second cell groups of the set of multiple cell groups, the one or more second cell groups associated with one or more second cell group configurations that are different from the first cell group configuration.

In some examples, to support transmitting the group triggered mobility message, the target cell group component 740 is capable of, configured to, or operable to support a means for transmitting, via the group triggered mobility message, an indication for the set of multiple UEs to transition from the first cell group to a single candidate cell group of the set of multiple cell groups.

In some examples, to support transmitting the group triggered mobility message, the target cell group component 740 is capable of, configured to, or operable to support a means for transmitting, via the group triggered mobility message, one or more indexes associated with the one or more second cell groups from among the set of multiple cell groups, where each index of the one or more indexes indicates a respective candidate cell group for a respective UE of the set of multiple UEs.

In some examples, to support transmitting the group triggered mobility message, the target cell group component 740 is capable of, configured to, or operable to support a means for transmitting, via the group triggered mobility message, a first index that indicates a subset of candidate cell groups including the one or more second cell groups, and a second index that indicates a first candidate cell group from among the subset of candidate cell groups.

In some examples, the first index and the second index are associated with the set of multiple UEs.

In some examples, the first index indicates the subset of candidate cell groups for the set of multiple UEs. In some examples, the second index indicates the first candidate cell group for the first UE.

In some examples, to support transmitting the group triggered mobility message, the mobility parameter component 745 is capable of, configured to, or operable to support a means for transmitting, via the group triggered mobility message, a first set of one or more parameters that are common to the set of multiple UEs and a second set of one or more parameters that are specific to the first UE.

In some examples, the first set of one or more parameters includes a bandwidth part identifier associated with the one or more second cell groups, a subset of one or more candidate cell groups from among the set of multiple cell groups, a transmission configuration indication state indication associated with the one or more second cell groups, a downlink indication associated with the one or more second cell groups, an uplink indication associated with the one or more second cell groups, or any combination thereof.

In some examples, the second set of one or more parameters indicates at least one cell group configuration of the set of multiple cell group configurations associated with the one or more second cell groups, a transmission configuration indication state indication associated with the one or more second cell groups, a timing advance value associated with the one or more second cell groups, or any combination thereof.

In some examples, to support transmitting the control signaling, the mobility parameter component 745 is capable of, configured to, or operable to support a means for transmitting, via the control signaling, an indication of one or more bit locations within the group triggered mobility message associated with a respective UE of the set of multiple UEs.

In some examples, the one or more bit locations include at least a first bit location associated with the first set of one or more parameters that are common to the set of multiple UEs.

In some examples, the one or more bit locations include at least a first bit location associated with the second set of one or more parameters that are specific to the first UE.

In some examples, to support transmitting the group triggered mobility message, the DCI component 750 is capable of, configured to, or operable to support a means for transmitting the group triggered mobility message that is a group downlink control information message that indicates for the set of multiple UEs to transition from the first cell group to the one or more second cell groups.

In some examples, to support transmitting the group triggered mobility message, the MAC component 755 is capable of, configured to, or operable to support a means for transmitting the group triggered mobility message that is a group medium access control-control element message that indicates for the set of multiple UEs to transition from the first cell group to the one or more second cell groups.

In some examples, to support transmitting the control signaling, the control signal component 725 is capable of, configured to, or operable to support a means for transmitting, to each UE of the set of multiple UEs, a respective unicast radio resource control message that indicates the set of multiple cell groups and the set of multiple cell group configurations.

In some examples, to support transmitting the group triggered mobility message, the mobility trigger component 735 is capable of, configured to, or operable to support a means for transmitting a group layer one mobility message or a group layer two mobility message.

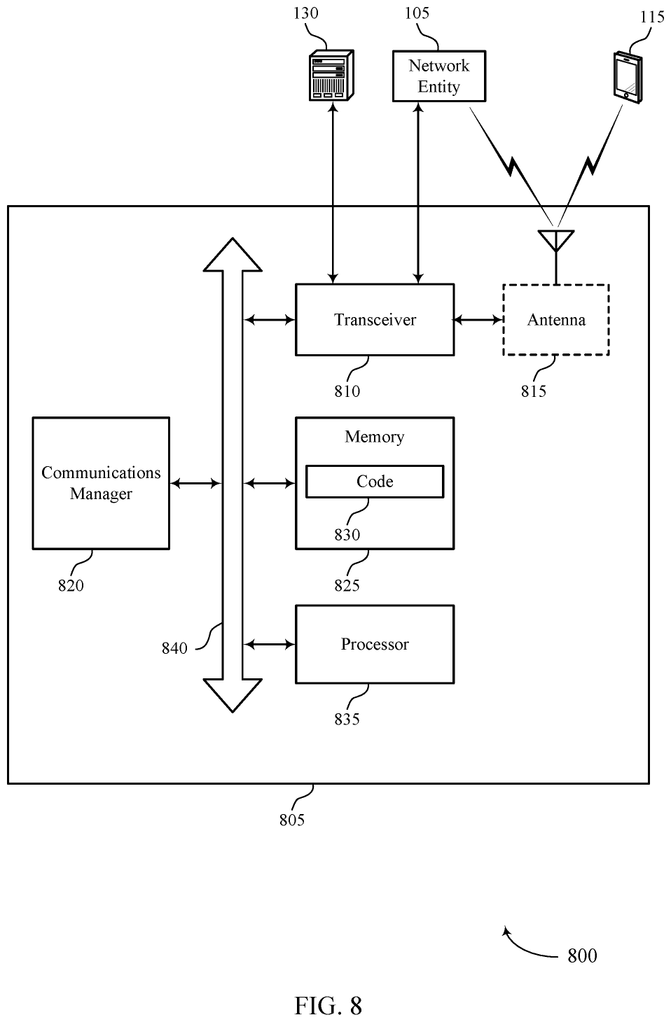

FIG. 8 shows a diagram of a system 800 including a device 805 that supports group common cell switching for network energy saving in accordance with one or more aspects of the present disclosure. The device 805 may be an example of or include the components of a device 505, a device 605, or a network entity 105 as described herein. The device 805 may communicate with one or more network entities 105, one or more UEs 115, or any combination thereof, which may include communications over one or more wired interfaces, over one or more wireless interfaces, or any combination thereof. The device 805 may include components that support outputting and obtaining communications, such as a communications manager 820, a transceiver 810, an antenna 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., a communication link 125, a backhaul communication link 120, a midhaul communication link 162, a fronthaul communication link 168).

The at least one memory 825 may include RAM, ROM, or any combination thereof. The at least one memory 825 may store computer-readable, computer-executable code 830 including instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may contain, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting group common cell switching for network energy saving). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825). In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. As such, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with other network entities 105, and may include a controller or scheduler for controlling communications with UEs 115 in cooperation with other network entities 105. In some examples, the communications manager 820 may support an X2 interface within an LTE/LTE-A wireless communications network technology to provide communication between network entities 105.

The communications manager 820 may support wireless communication in accordance with examples as disclosed herein. For example, the communications manager 820 is capable of, configured to, or operable to support a means for transmitting control signaling that indicates a set of multiple cell groups and a set of multiple cell group configurations, each cell group associated with a respective cell group configuration of the set of multiple cell group configurations. The communications manager 820 is capable of, configured to, or operable to support a means for communicating with a first UE of a set of multiple UEs via a first cell group of the set of multiple cell groups in accordance with a first cell group configuration of the set of multiple cell group configurations. The communications manager 820 is capable of, configured to, or operable to support a means for transmitting, via the first cell group, a group triggered mobility message that indicates for the set of multiple UEs to transition from the first cell group to one or more second cell groups of the set of multiple cell groups, the one or more second cell groups associated with one or more second cell group configurations that are different from the first cell group configuration.

By including or configuring the communications manager 820 in accordance with examples as described herein, the device 805 may support techniques for improved communication reliability, reduced latency, reduced power consumption, more efficient utilization of communication resources, longer battery life, and improved utilization of processing capability, among other examples.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of group common cell switching for network energy saving as described herein, or the at least one processor 835 and the at least one memory 825 may be otherwise configured to, individually or collectively, perform or support such operations.

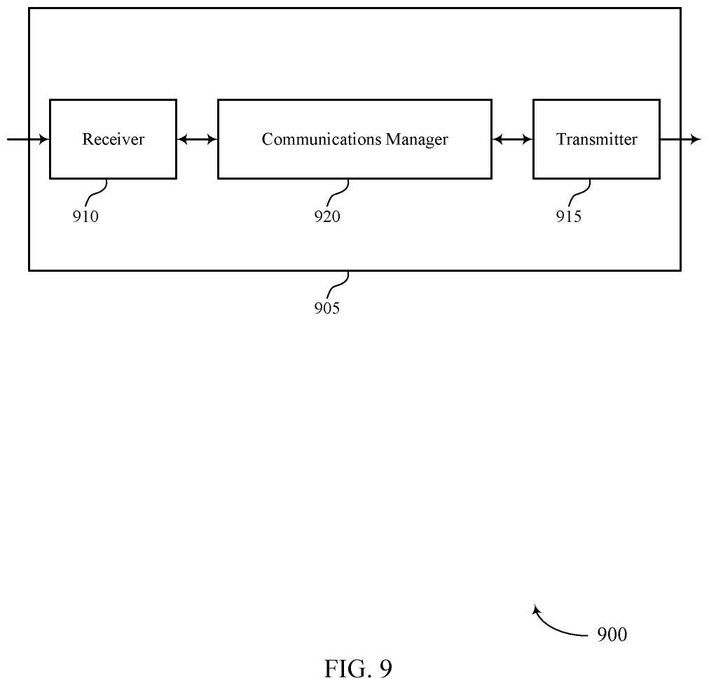

FIG. 9 shows a block diagram 900 of a device 905 that supports group common cell switching for network energy saving in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to group common cell switching for network energy saving). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to group common cell switching for network energy saving). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of group common cell switching for network energy saving as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 is capable of, configured to, or operable to support a means for receiving control signaling that indicates a set of multiple cell groups and a set of multiple cell group configurations, each cell group associated with a respective cell group configuration of the set of multiple cell group configurations. The communications manager 920 is capable of, configured to, or operable to support a means for communicating via a first cell group of the set of multiple cell groups in accordance with a first cell group configuration of the set of multiple cell group configurations. The communications manager 920 is capable of, configured to, or operable to support a means for receiving, via the first cell group, a group triggered mobility message that indicates for the UE and one or more second UEs to transition from the first cell group to one or more second cell groups of the set of multiple cell groups, the one or more second cell groups associated with one or more second cell group configurations that are different than the first cell group configuration.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, and more efficient utilization of communication resources, among other examples.

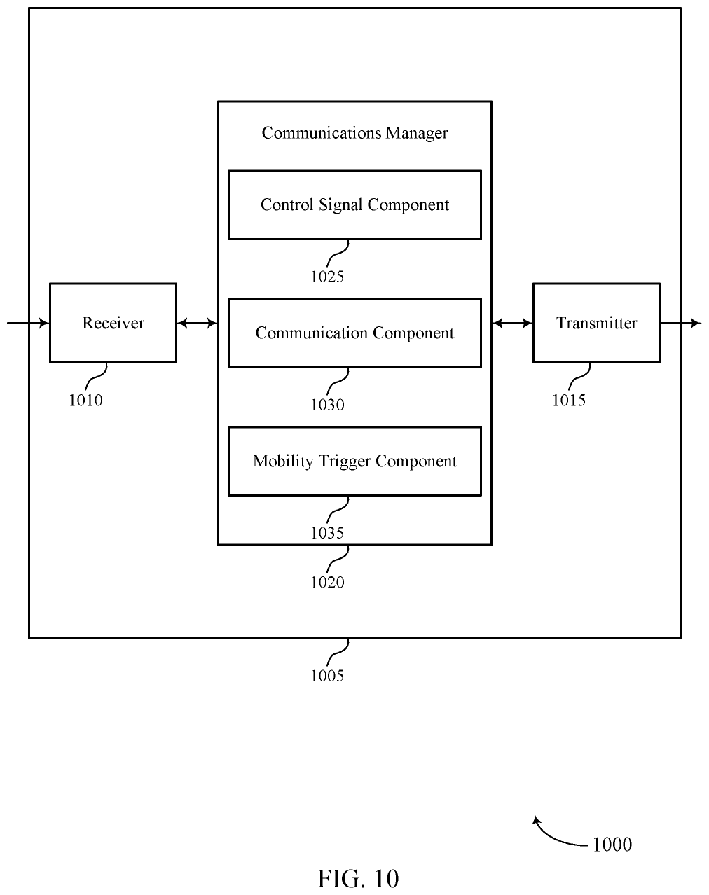

FIG. 10 shows a block diagram 1000 of a device 1005 that supports group common cell switching for network energy saving in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to group common cell switching for network energy saving). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to group common cell switching for network energy saving). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of group common cell switching for network energy saving as described herein. For example, the communications manager 1020 may include a control signal component 1025, a communication component 1030, a mobility trigger component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The control signal component 1025 is capable of, configured to, or operable to support a means for receiving control signaling that indicates a set of multiple cell groups and a set of multiple cell group configurations, each cell group associated with a respective cell group configuration of the set of multiple cell group configurations. The communication component 1030 is capable of, configured to, or operable to support a means for communicating via a first cell group of the set of multiple cell groups in accordance with a first cell group configuration of the set of multiple cell group configurations. The mobility trigger component 1035 is capable of, configured to, or operable to support a means for receiving, via the first cell group, a group triggered mobility message that indicates for the UE and one or more second UEs to transition from the first cell group to one or more second cell groups of the set of multiple cell groups, the one or more second cell groups associated with one or more second cell group configurations that are different than the first cell group configuration.

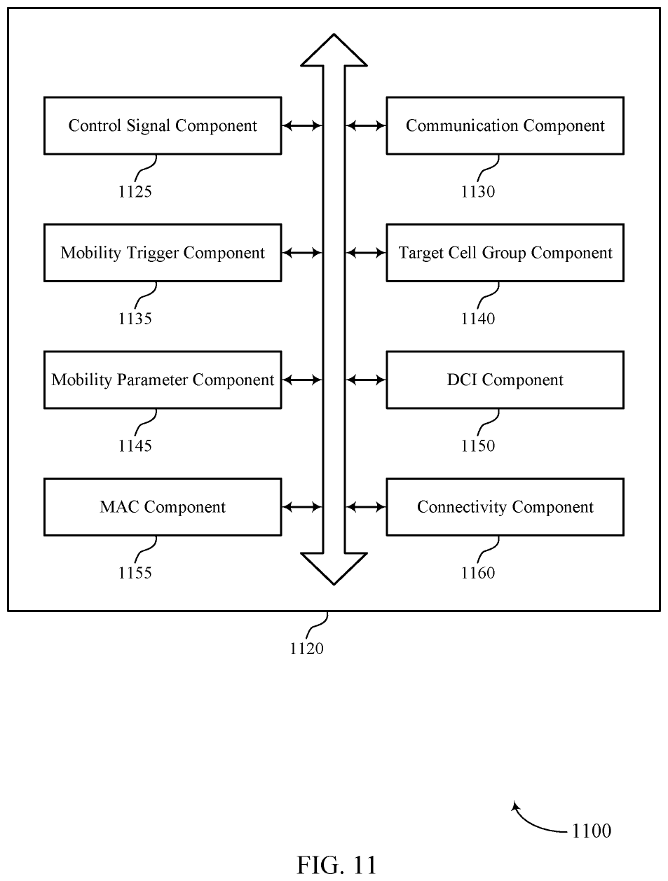

FIG. 11 shows a block diagram 1100 of a communications manager 1120 that supports group common cell switching for network energy saving in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of group common cell switching for network energy saving as described herein. For example, the communications manager 1120 may include a control signal component 1125, a communication component 1130, a mobility trigger component 1135, a target cell group component 1140, a mobility parameter component 1145, a DCI component 1150, a MAC component 1155, a connectivity component 1160, or any combination thereof. Each of these components, or components or subcomponents thereof (e.g., one or more processors, one or more memories), may communicate, directly or indirectly, with one another (e.g., via one or more buses).

The communications manager 1120 may support wireless communication in accordance with examples as disclosed herein. The control signal component 1125 is capable of, configured to, or operable to support a means for receiving control signaling that indicates a set of multiple cell groups and a set of multiple cell group configurations, each cell group associated with a respective cell group configuration of the set of multiple cell group configurations. The communication component 1130 is capable of, configured to, or operable to support a means for communicating via a first cell group of the set of multiple cell groups in accordance with a first cell group configuration of the set of multiple cell group configurations. The mobility trigger component 1135 is capable of, configured to, or operable to support a means for receiving, via the first cell group, a group triggered mobility message that indicates for the UE and one or more second UEs to transition from the first cell group to one or more second cell groups of the set of multiple cell groups, the one or more second cell groups associated with one or more second cell group configurations that are different than the first cell group configuration.

In some examples, to support receiving the group triggered mobility message, the target cell group component 1140 is capable of, configured to, or operable to support a means for receiving, via the group triggered mobility message, an indication for the UE and the one or more second UEs to transition from the first cell group to a single candidate cell group of the set of multiple cell groups.

In some examples, to support receiving the group triggered mobility message, the target cell group component 1140 is capable of, configured to, or operable to support a means for receiving, via the group triggered mobility message, one or more indexes associated with the one or more second cell groups from among the set of multiple cell groups, where each index of the one or more indexes indicates a respective cell group for a respective UE of a group of UEs including the UE and the one or more second UEs.

In some examples, to support receiving the group triggered mobility message, the target cell group component 1140 is capable of, configured to, or operable to support a means for receiving, via the group triggered mobility message, a first index that indicates a subset of candidate cell groups including the one or more second cell groups, and a second index that indicates a first candidate cell group from among the subset of candidate cell groups.

In some examples, to support receiving the group triggered mobility message, the mobility parameter component 1145 is capable of, configured to, or operable to support a means for receiving, via the group triggered mobility message, a first set of one or more parameters that are common to the UE and the one or more second UEs and a second set of one or more parameters that are specific to the UE.

In some examples, the mobility parameter component 1145 is capable of, configured to, or operable to support a means for receiving, via the control signaling, an indication of one or more bit locations within the group triggered mobility message associated with the UE.

In some examples, the one or more bit locations include at least a first bit location associated with the first set of one or more parameters that are common to the UE and the one or more second UEs.

In some examples, the one or more bit locations include at least a first bit location associated with the second set of one or more parameters that are specific to the UE.

In some examples, to support receiving the group triggered mobility message, the DCI component 1150 is capable of, configured to, or operable to support a means for receiving the group triggered mobility message that is a group downlink control information message that indicates for the UE and the one or more second UEs to transition from the first cell group to the one or more second cell groups.

In some examples, to support receiving the group triggered mobility message, the MAC component 1155 is capable of, configured to, or operable to support a means for receiving the group triggered mobility message that is a group medium access control-control element message that indicates for the UE and the one or more second UEs to transition from the first cell group to the one or more second cell groups.

In some examples, the connectivity component 1160 is capable of, configured to, or operable to support a means for transmitting one or more messages for establishing connectivity with a second cell group of the one or more second cell groups based on the group triggered mobility message.

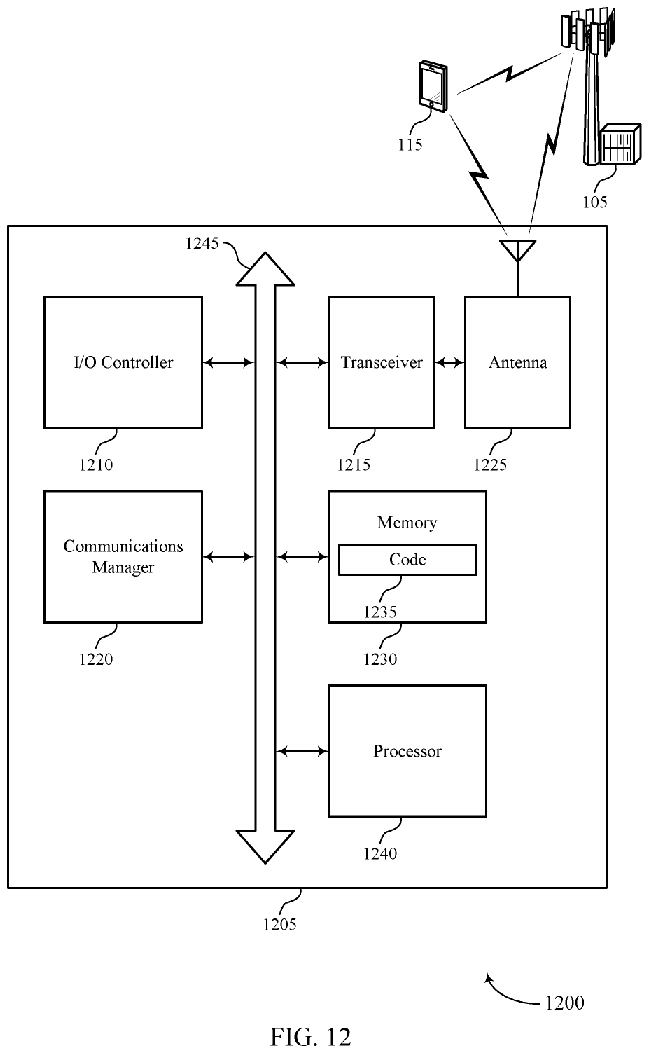

FIG. 12 shows a diagram of a system 1200 including a device 1205 that supports group common cell switching for network energy saving in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable code 1235 including instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may contain, among other things, a basic I/O system (BIOS) which may control basic hardware or software operation such as the interaction with peripheral components or devices.

The at least one processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting group common cell switching for network energy saving). For example, the device 1205 or a component of the device 1205 may include at least one processor 1240 and at least one memory 1230 coupled with or to the at least one processor 1240, the at least one processor 1240 and at least one memory 1230 configured to perform various functions described herein. In some examples, the at least one processor 1240 may include multiple processors and the at least one memory 1230 may include multiple memories. One or more of the multiple processors may be coupled with one or more of the multiple memories, which may, individually or collectively, be configured to perform various functions herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. As such, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1230 or otherwise, to perform one or more of the functions described herein.

The communications manager 1220 may support wireless communication in accordance with examples as disclosed herein. For example, the communications manager 1220 is capable of, configured to, or operable to support a means for receiving control signaling that indicates a set of multiple cell groups and a set of multiple cell group configurations, each cell group associated with a respective cell group configuration of the set of multiple cell group configurations. The communications manager 1220 is capable of, configured to, or operable to support a means for communicating via a first cell group of the set of multiple cell groups in accordance with a first cell group configuration of the set of multiple cell group configurations. The communications manager 1220 is capable of, configured to, or operable to support a means for receiving, via the first cell group, a group triggered mobility message that indicates for the UE and one or more second UEs to transition from the first cell group to one or more second cell groups of the set of multiple cell groups, the one or more second cell groups associated with one or more second cell group configurations that are different than the first cell group configuration.

By including or configuring the communications manager 1220 in accordance with examples as described herein, the device 1205 may support techniques for improved communication reliability, reduced latency, reduced power consumption, more efficient utilization of communication resources, longer battery life, and improved utilization of processing capability, among other examples.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of group common cell switching for network energy saving as described herein, or the at least one processor 1240 and the at least one memory 1230 may be otherwise configured to, individually or collectively, perform or support such operations.

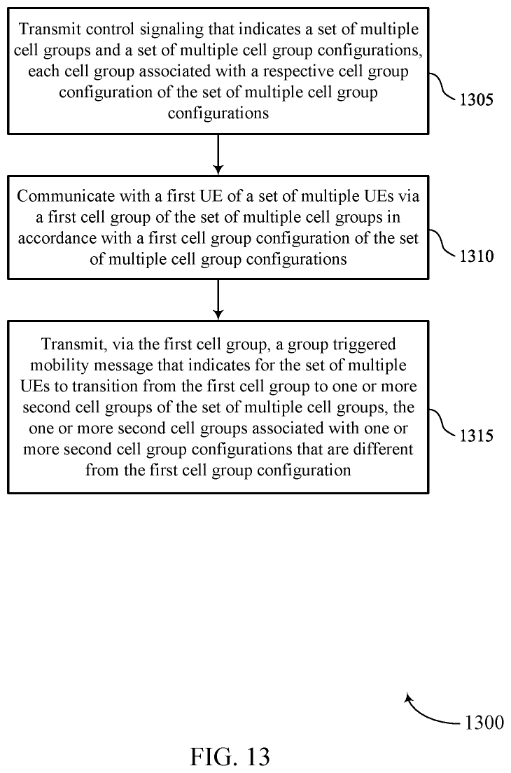

FIG. 13 shows a flowchart illustrating a method 1300 that supports group common cell switching for network energy saving in accordance with aspects of the present disclosure. The operations of the method 1300 may be implemented by a network entity or its components as described herein. For example, the operations of the method 1300 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1305, the method may include transmitting control signaling that indicates a set of multiple cell groups and a set of multiple cell group configurations, each cell group associated with a respective cell group configuration of the set of multiple cell group configurations. The operations of block 1305 may be performed in accordance with examples as disclosed herein. In some examples, aspects of the operations of 1305 may be performed by a control signal component 725 as described with reference to FIG. 7.

At 1310, the method may include communicating with a first UE of a set of multiple UEs via a first cell group of the set of multiple cell groups in accordance with a first cell group configuration of the set of multiple cell group configurations. The operations of block 1310 may be performed in accordance with examples as disclosed herein. In some examples, aspects of the operations of 1310 may be performed by a communication component 730 as described with reference to FIG. 7.

At 1315, the method may include transmitting, via the first cell group, a group triggered mobility message that indicates for the set of multiple UEs to transition from the first cell group to one or more second cell groups of the set of multiple cell groups, the one or more second cell groups associated with one or more second cell group configurations that are different from the first cell group configuration. The operations of block 1315 may be performed in accordance with examples as disclosed herein. In some examples, aspects of the operations of 1315 may be performed by a mobility trigger component 735 as described with reference to FIG. 7.

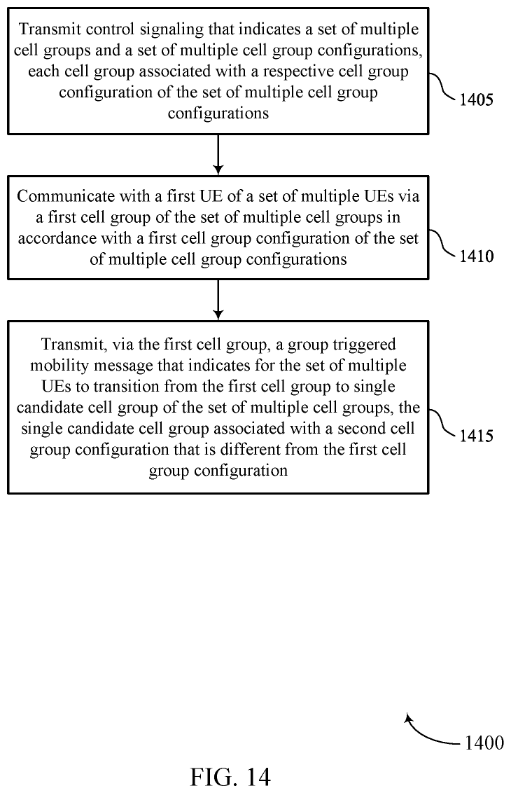

FIG. 14 shows a flowchart illustrating a method 1400 that supports group common cell switching for network energy saving in accordance with aspects of the present disclosure. The operations of the method 1400 may be implemented by a network entity or its components as described herein. For example, the operations of the method 1400 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1405, the method may include transmitting control signaling that indicates a set of multiple cell groups and a set of multiple cell group configurations, each cell group associated with a respective cell group configuration of the set of multiple cell group configurations. The operations of block 1405 may be performed in accordance with examples as disclosed herein. In some examples, aspects of the operations of 1405 may be performed by a control signal component 725 as described with reference to FIG. 7.

At 1410, the method may include communicating with a first UE of a set of multiple UEs via a first cell group of the set of multiple cell groups in accordance with a first cell group configuration of the set of multiple cell group configurations. The operations of block 1410 may be performed in accordance with examples as disclosed herein. In some examples, aspects of the operations of 1410 may be performed by a communication component 730 as described with reference to FIG. 7.

At 1415, the method may include transmitting, via the first cell group, a group triggered mobility message that indicates for the set of multiple UEs to transition from the first cell group to a single candidate cell group of the set of multiple cell groups, the single candidate second cell group associated with a second cell group configuration that is different from the first cell group configuration. The operations of block 1415 may be performed in accordance with examples as disclosed herein. In some examples, aspects of the operations of 1415 may be performed by a mobility trigger component 735 as described with reference to FIG. 7.

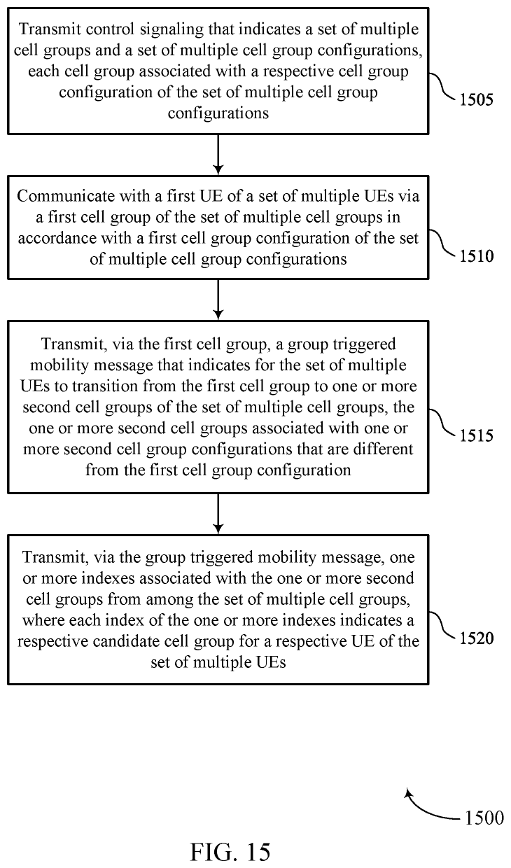

FIG. 15 shows a flowchart illustrating a method 1500 that supports group common cell switching for network energy saving in accordance with aspects of the present disclosure. The operations of the method 1500 may be implemented by a network entity or its components as described herein. For example, the operations of the method 1500 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1505, the method may include transmitting control signaling that indicates a set of multiple cell groups and a set of multiple cell group configurations, each cell group associated with a respective cell group configuration of the set of multiple cell group configurations. The operations of block 1505 may be performed in accordance with examples as disclosed herein. In some examples, aspects of the operations of 1505 may be performed by a control signal component 725 as described with reference to FIG. 7.

At 1510, the method may include communicating with a first UE of a set of multiple UEs via a first cell group of the set of multiple cell groups in accordance with a first cell group configuration of the set of multiple cell group configurations. The operations of block 1510 may be performed in accordance with examples as disclosed herein. In some examples, aspects of the operations of 1510 may be performed by a communication component 730 as described with reference to FIG. 7.

At 1515, the method may include transmitting, via the first cell group, a group triggered mobility message that indicates for the set of multiple UEs to transition from the first cell group to one or more second cell groups of the set of multiple cell groups, the one or more second cell groups associated with one or more second cell group configurations that are different from the first cell group configuration. The operations of block 1515 may be performed in accordance with examples as disclosed herein. In some examples, aspects of the operations of 1515 may be performed by a mobility trigger component 735 as described with reference to FIG. 7.

At 1520, the method may include transmitting, via the group triggered mobility message, one or more indexes associated with the one or more second cell groups from among the set of multiple cell groups, where each index of the one or more indexes indicates a respective candidate cell group for a respective UE of the set of multiple UEs. The operations of block 1520 may be performed in accordance with examples as disclosed herein. In some examples, aspects of the operations of 1520 may be performed by a target cell group component 740 as described with reference to FIG. 7.

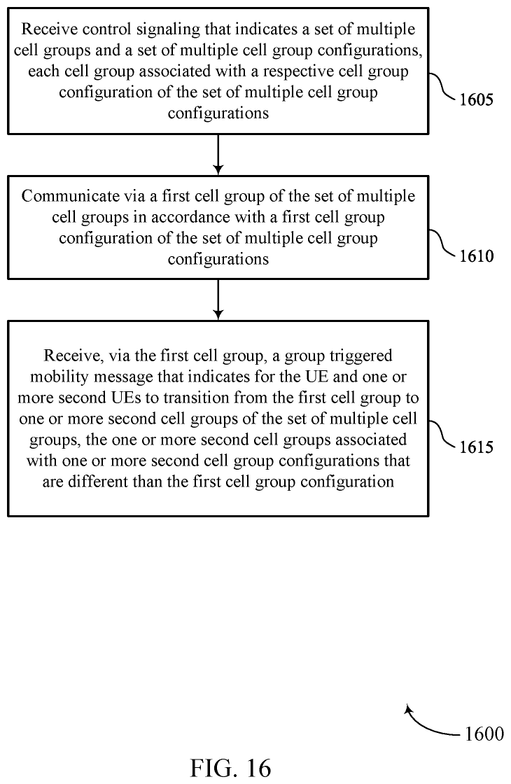

FIG. 16 shows a flowchart illustrating a method 1600 that supports group common cell switching for network energy saving in accordance with aspects of the present disclosure. The operations of the method 1600 may be implemented by a UE or its components as described herein. For example, the operations of the method 1600 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 1605, the method may include receiving control signaling that indicates a set of multiple cell groups and a set of multiple cell group configurations, each cell group associated with a respective cell group configuration of the set of multiple cell group configurations. The operations of block 1605 may be performed in accordance with examples as disclosed herein. In some examples, aspects of the operations of 1605 may be performed by a control signal component 1125 as described with reference to FIG. 11.

At 1610, the method may include communicating via a first cell group of the set of multiple cell groups in accordance with a first cell group configuration of the set of multiple cell group configurations. The operations of block 1610 may be performed in accordance with examples as disclosed herein. In some examples, aspects of the operations of 1610 may be performed by a communication component 1130 as described with reference to FIG. 11.

At 1615, the method may include receiving, via the first cell group, a group triggered mobility message that indicates for the UE and one or more second UEs to transition from the first cell group to one or more second cell groups of the set of multiple cell groups, the one or more second cell groups associated with one or more second cell group configurations that are different than the first cell group configuration. The operations of block 1615 may be performed in accordance with examples as disclosed herein. In some examples, aspects of the operations of 1615 may be performed by a mobility trigger component 1135 as described with reference to FIG. 11.

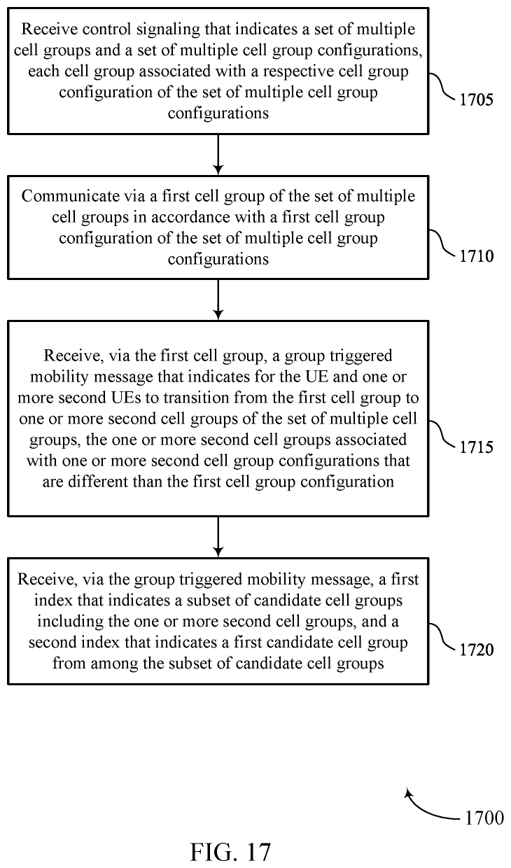

FIG. 17 shows a flowchart illustrating a method 1700 that supports group common cell switching for network energy saving in accordance with aspects of the present disclosure. The operations of the method 1700 may be implemented by a UE or its components as described herein. For example, the operations of the method 1700 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 1705, the method may include receiving control signaling that indicates a set of multiple cell groups and a set of multiple cell group configurations, each cell group associated with a respective cell group configuration of the set of multiple cell group configurations. The operations of block 1705 may be performed in accordance with examples as disclosed herein. In some examples, aspects of the operations of 1705 may be performed by a control signal component 1125 as described with reference to FIG. 11.

At 1710, the method may include communicating via a first cell group of the set of multiple cell groups in accordance with a first cell group configuration of the set of multiple cell group configurations. The operations of block 1710 may be performed in accordance with examples as disclosed herein. In some examples, aspects of the operations of 1710 may be performed by a communication component 1130 as described with reference to FIG. 11.

At 1715, the method may include receiving, via the first cell group, a group triggered mobility message that indicates for the UE and one or more second UEs to transition from the first cell group to one or more second cell groups of the set of multiple cell groups, the one or more second cell groups associated with one or more second cell group configurations that are different than the first cell group configuration. The operations of block 1715 may be performed in accordance with examples as disclosed herein. In some examples, aspects of the operations of 1715 may be performed by a mobility trigger component 1135 as described with reference to FIG. 11.

At 1720, the method may include receiving, via the group triggered mobility message, a first index that indicates a subset of candidate cell groups including the one or more second cell groups, and a second index that indicates a first candidate cell group from among the subset of candidate cell groups. The operations of block 1720 may be performed in accordance with examples as disclosed herein. In some examples, aspects of the operations of 1720 may be performed by a target cell group component 1140 as described with reference to FIG. 11.

The following provides an overview of aspects of the present disclosure:

Aspect 1: A method for wireless communication at a network entity, comprising: transmitting control signaling that indicates a plurality of cell groups and a plurality of cell group configurations, each cell group associated with a respective cell group configuration of the plurality of cell group configurations; communicating with a first UE of a plurality of UEs via a first cell group of the plurality of cell groups in accordance with a first cell group configuration of the plurality of cell group configurations; and transmitting, via the first cell group, a group triggered mobility message that indicates for the plurality of UEs to transition from the first cell group to one or more second cell groups of the plurality of cell groups, the one or more second cell groups associated with one or more second cell group configurations that are different from the first cell group configuration.

Aspect 2: The method of aspect 1, wherein transmitting the group triggered mobility message comprises: transmitting, via the group triggered mobility message, an indication for the plurality of UEs to transition from the first cell group to a single candidate cell group of the plurality of cell groups.

Aspect 3: The method of aspect 1, wherein transmitting the group triggered mobility message comprises: transmitting, via the group triggered mobility message, one or more indexes associated with the one or more second cell groups from among the plurality of cell groups, wherein each index of the one or more indexes indicates a respective candidate cell group for a respective UE of the plurality of UEs.

Aspect 4: The method of aspect 1, wherein transmitting the group triggered mobility message comprises: transmitting, via the group triggered mobility message, a first index that indicates a subset of candidate cell groups comprising the one or more second cell groups, and a second index that indicates a first candidate cell group from among the subset of candidate cell groups.

Aspect 5: The method of aspect 4, wherein the first index and the second index are associated with the plurality of UEs.

Aspect 6: The method of aspect 4, wherein the first index indicates the subset of candidate cell groups for the plurality of UEs; and the second index indicates the first candidate cell group for the first UE.

Aspect 7: The method of any of aspects 1 through 6, wherein transmitting the group triggered mobility message comprises: transmitting, via the group triggered mobility message, a first set of one or more parameters that are common to the plurality of UEs and a second set of one or more parameters that are specific to the first UE.

Aspect 8: The method of aspect 7, wherein the first set of one or more parameters comprises a BWP ID associated with the one or more second cell groups, a subset of one or more candidate cell groups from among the plurality of cell groups, a TCI state indication associated with the one or more second cell groups, a downlink indication associated with the one or more second cell groups, an uplink indication associated with the one or more second cell groups, or any combination thereof.

Aspect 9: The method of any of aspects 7 through 8, wherein the second set of one or more parameters indicates at least one cell group configuration of the plurality of cell group configurations associated with the one or more second cell groups, a TCI state indication associated with the one or more second cell groups, a timing advance value associated with the one or more second cell groups, or any combination thereof.

Aspect 10: The method of any of aspects 7 through 9, wherein transmitting the control signaling comprises: transmitting, via the control signaling, an indication of one or more bit locations within the group triggered mobility message associated with a respective UE of the plurality of UEs.

Aspect 11: The method of aspect 10, wherein the one or more bit locations comprise at least a first bit location associated with the first set of one or more parameters that are common to the plurality of UEs.

Aspect 12: The method of aspect 10, wherein the one or more bit locations comprise at least a first bit location associated with the second set of one or more parameters that are specific to the first UE.

Aspect 13: The method of any of aspects 1 through 12, wherein transmitting the group triggered mobility message comprises: transmitting the group triggered mobility message that is a group DCI message that indicates for the plurality of UEs to transition from the first cell group to the one or more second cell groups.

Aspect 14: The method of any of aspects 1 through 12, wherein transmitting the group triggered mobility message comprises: transmitting the group triggered mobility message that is a group MAC-CE message that indicates for the plurality of UEs to transition from the first cell group to the one or more second cell groups.

Aspect 15: The method of any of aspects 1 through 14, wherein transmitting the control signaling comprises: transmitting, to each UE of the plurality of UEs, a respective unicast RRC message that indicates the plurality of cell groups and the plurality of cell group configurations.

Aspect 16: The method of any of aspects 1 through 15, wherein transmitting the group triggered mobility message comprises: transmitting a group layer one mobility message or a group layer two mobility message.

Aspect 17: A method for wireless communication at a UE, comprising: receiving control signaling that indicates a plurality of cell groups and a plurality of cell group configurations, each cell group associated with a respective cell group configuration of the plurality of cell group configurations; communicating via a first cell group of the plurality of cell groups in accordance with a first cell group configuration of the plurality of cell group configurations; and receiving, via the first cell group, a group triggered mobility message that indicates for the UE and one or more second UEs to transition from the first cell group to one or more second cell groups of the plurality of cell groups, the one or more second cell groups associated with one or more second cell group configurations that are different than the first cell group configuration.

Aspect 18: The method of aspect 17, wherein receiving the group triggered mobility message comprises: receiving, via the group triggered mobility message, an indication for the UE and the one or more second UEs to transition from the first cell group to a single candidate cell group of the plurality of cell groups.

Aspect 19: The method of aspect 17, wherein receiving the group triggered mobility message comprises: receiving, via the group triggered mobility message, one or more indexes associated with the one or more second cell groups from among the plurality of cell groups, wherein each index of the one or more indexes indicates a respective cell group for a respective UE of a group of UEs comprising the UE and the one or more second UEs.

Aspect 20: The method of aspect 17, wherein receiving the group triggered mobility message comprises: receiving, via the group triggered mobility message, a first index that indicates a subset of candidate cell groups comprising the one or more second cell groups, and a second index that indicates a first candidate cell group from among the subset of candidate cell groups.

Aspect 21: The method of any of aspects 17 through 20, wherein receiving the group triggered mobility message comprises: receiving, via the group triggered mobility message, a first set of one or more parameters that are common to the UE and the one or more second UEs and a second set of one or more parameters that are specific to the UE.

Aspect 22: The method of aspect 21, further comprising: receiving, via the control signaling, an indication of one or more bit locations within the group triggered mobility message associated with the UE.

Aspect 23: The method of aspect 22, wherein the one or more bit locations comprise at least a first bit location associated with the first set of one or more parameters that are common to the UE and the one or more second UEs.

Aspect 24: The method of aspect 22, wherein the one or more bit locations comprise at least a first bit location associated with the second set of one or more parameters that are specific to the UE.

Aspect 25: The method of any of aspects 17 through 24, wherein receiving the group triggered mobility message comprises: receiving the group triggered mobility message that is a group DCI message that indicates for the UE and the one or more second UEs to transition from the first cell group to the one or more second cell groups.

Aspect 26: The method of any of aspects 17 through 24, wherein receiving the group triggered mobility message comprises: receiving the group triggered mobility message that is a group MAC-CE message that indicates for the UE and the one or more second UEs to transition from the first cell group to the one or more second cell groups.

Aspect 27: The method of any of aspects 17 through 26, further comprising: transmitting one or more messages for establishing connectivity with a second cell group of the one or more second cell groups based at least in part on the group triggered mobility message.

Aspect 28: A network entity for wireless communication, comprising one or more memories storing processor-executable code, and one or more processors coupled with the one or more memories and individually or collectively operable to execute the code to cause the network entity to perform a method of any of aspects 1 through 16.

Aspect 29: A network entity for wireless communication, comprising at least one means for performing a method of any of aspects 1 through 16.

Aspect 30: A non-transitory computer-readable medium storing code for wireless communication, the code comprising instructions executable by a processor to perform a method of any of aspects 1 through 16.

Aspect 31: A UE for wireless communication, comprising one or more memories storing processor-executable code, and one or more processors coupled with the one or more memories and individually or collectively operable to execute the code to cause the UE to perform a method of any of aspects 17 through 27.

Aspect 32: A UE for wireless communication, comprising at least one means for performing a method of any of aspects 17 through 27.

Aspect 33: A non-transitory computer-readable medium storing code for wireless communication, the code comprising instructions executable by a processor to perform a method of any of aspects 17 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
transmit control signaling that indicates a plurality of cell groups and a plurality of cell group configurations, each cell group associated with a respective cell group configuration of the plurality of cell group configurations;
communicate with a first UE of a plurality of UEs via a first cell group of the plurality of cell groups in accordance with a first cell group configuration of the plurality of cell group configurations; and
transmit, via the first cell group, a group triggered mobility message that indicates for the plurality of UEs to transition from the first cell group to one or more second cell groups of the plurality of cell groups, the one or more second cell groups associated with one or more second cell group configurations that are different from the first cell group configuration.

2. The network entity of claim 1, wherein, to transmit the group triggered mobility message, the one or more processors are individually or collectively operable to execute the code to cause the network entity to:
transmit, via the group triggered mobility message, an indication for the plurality of UEs to transition from the first cell group to a single candidate cell group of the plurality of cell groups.

3. The network entity of claim 1, wherein, to transmit the group triggered mobility message, the one or more processors are individually or collectively operable to execute the code to cause the network entity to:
transmit, via the group triggered mobility message, one or more indexes associated with the one or more second cell groups from among the plurality of cell groups, wherein each index of the one or more indexes indicates a respective candidate cell group for a respective UE of the plurality of UEs.

4. The network entity of claim 1, wherein, to transmit the group triggered mobility message, the one or more processors are individually or collectively operable to execute the code to cause the network entity to:
transmit, via the group triggered mobility message, a first index that indicates a subset of candidate cell groups comprising the one or more second cell groups, and a second index that indicates a first candidate cell group from among the subset of candidate cell groups.

5. The network entity of claim 4, wherein the first index and the second index are associated with the plurality of UEs.

6. The network entity of claim 4, wherein:
the first index indicates the subset of candidate cell groups for the plurality of UEs; and
the second index indicates the first candidate cell group for the first UE.

7. The network entity of claim 1, wherein, to transmit the group triggered mobility message, the one or more processors are individually or collectively operable to execute the code to cause the network entity to:
transmit, via the group triggered mobility message, a first set of one or more parameters that are common to the plurality of UEs and a second set of one or more parameters that are specific to the first UE.

8. The network entity of claim 7, wherein the first set of one or more parameters comprises a bandwidth part identifier associated with the one or more second cell groups, a subset of one or more candidate cell groups from among the plurality of cell groups, a transmission configuration indication state indication associated with the one or more second cell groups, a downlink indication associated with the one or more second cell groups, an uplink indication associated with the one or more second cell groups, or any combination thereof.

9. The network entity of claim 7, wherein the second set of one or more parameters indicates at least one cell group configuration of the plurality of cell group configurations associated with the one or more second cell groups, a transmission configuration indication state indication associated with the one or more second cell groups, a timing advance value associated with the one or more second cell groups, or any combination thereof.

10. The network entity of claim 7, wherein, to transmit the control signaling, the one or more processors are individually or collectively operable to execute the code to cause the network entity to:
transmit, via the control signaling, an indication of one or more bit locations within the group triggered mobility message associated with a respective UE of the plurality of UEs.

11. The network entity of claim 10, wherein the one or more bit locations comprise at least a first bit location associated with the first set of one or more parameters that are common to the plurality of UEs.

12. The network entity of claim 10, wherein the one or more bit locations comprise at least a first bit location associated with the second set of one or more parameters that are specific to the first UE.

13. The network entity of claim 1, wherein, to transmit the group triggered mobility message, the one or more processors are individually or collectively operable to execute the code to cause the network entity to:
transmit the group triggered mobility message that is a group downlink control information message that indicates for the plurality of UEs to transition from the first cell group to the one or more second cell groups.

14. The network entity of claim 1, wherein, to transmit the group triggered mobility message, the one or more processors are individually or collectively operable to execute the code to cause the network entity to:
transmit the group triggered mobility message that is a group medium access control-control element message that indicates for the plurality of UEs to transition from the first cell group to the one or more second cell groups.

15. The network entity of claim 1, wherein, to transmit the control signaling, the one or more processors are individually or collectively operable to execute the code to cause the network entity to:
transmit, to each UE of the plurality of UEs, a respective unicast radio resource control message that indicates the plurality of cell groups and the plurality of cell group configurations.

16. The network entity of claim 1, wherein, to transmit the group triggered mobility message, the one or more processors are individually or collectively operable to execute the code to cause the network entity to:
transmit a group layer one mobility message or a group layer two mobility message.

17. A user equipment (UE), comprising:
one or more memories storing processor-executable code; and
one or more processors coupled with the one or more memories and individually or collectively operable to execute the code to cause the UE to:
receive control signaling that indicates a plurality of cell groups and a plurality of cell group configurations, each cell group associated with a respective cell group configuration of the plurality of cell group configurations;
communicate via a first cell group of the plurality of cell groups in accordance with a first cell group configuration of the plurality of cell group configurations; and
receive, via the first cell group, a group triggered mobility message that indicates for the UE and one or more second UEs to transition from the first cell group to one or more second cell groups of the plurality of cell groups, the one or more second cell groups associated with one or more second cell group configurations that are different than the first cell group configuration.

18. The UE of claim 17, wherein, to receive the group triggered mobility message, the one or more processors are individually or collectively operable to execute the code to cause the UE to:
receive, via the group triggered mobility message, an indication for the UE and the one or more second UEs to transition from the first cell group to a single candidate cell group of the plurality of cell groups.

19. The UE of claim 17, wherein, to receive the group triggered mobility message, the one or more processors are individually or collectively operable to execute the code to cause the UE to:
receive, via the group triggered mobility message, one or more indexes associated with the one or more second cell groups from among the plurality of cell groups, wherein each index of the one or more indexes indicates a respective cell group for a respective UE of a group of UEs comprising the UE and the one or more second UEs.

20. The UE of claim 17, wherein, to receive the group triggered mobility message, the one or more processors are individually or collectively operable to execute the code to cause the UE to:
receive, via the group triggered mobility message, a first index that indicates a subset of candidate cell groups comprising the one or more second cell groups, and a second index that indicates a first candidate cell group from among the subset of candidate cell groups.

21. The UE of claim 17, wherein, to receive the group triggered mobility message, the one or more processors are individually or collectively operable to execute the code to cause the UE to:
receive, via the group triggered mobility message, a first set of one or more parameters that are common to the UE and the one or more second UEs and a second set of one or more parameters that are specific to the UE.

22. The UE of claim 21, wherein the one or more processors are individually or collectively further operable to execute the code to cause the UE to:
receive, via the control signaling, an indication of one or more bit locations within the group triggered mobility message associated with the UE.

23. The UE of claim 17, wherein, to receive the group triggered mobility message, the one or more processors are individually or collectively operable to execute the code to cause the UE to:
receive the group triggered mobility message that is a group downlink control information message that indicates for the UE and the one or more second UEs to transition from the first cell group to the one or more second cell groups.

24. The UE of claim 17, wherein, to receive the group triggered mobility message, the one or more processors are individually or collectively operable to execute the code to cause the UE to:
receive the group triggered mobility message that is a group medium access control-control element message that indicates for the UE and the one or more second UEs to transition from the first cell group to the one or more second cell groups.

25. The UE of claim 17, wherein the one or more processors are individually or collectively further operable to execute the code to cause the UE to:
transmit one or more messages for establishing connectivity with a second cell group of the one or more second cell groups based at least in part on the group triggered mobility message.

26. A method for wireless communication at a network entity, comprising:
transmitting control signaling that indicates a plurality of cell groups and a plurality of cell group configurations, each cell group associated with a respective cell group configuration of the plurality of cell group configurations;
communicating with a first UE of a plurality of UEs via a first cell group of the plurality of cell groups in accordance with a first cell group configuration of the plurality of cell group configurations; and
transmitting, via the first cell group, a group triggered mobility message that indicates for the plurality of UEs to transition from the first cell group to one or more second cell groups of the plurality of cell groups, the one or more second cell groups associated with one or more second cell group configurations that are different from the first cell group configuration.

27. The method of claim 26, wherein transmitting the group triggered mobility message comprises:
transmitting, via the group triggered mobility message, an indication for the plurality of UEs to transition from the first cell group to a single candidate cell group of the plurality of cell groups.

28. The method of claim 26, wherein transmitting the group triggered mobility message comprises:
transmitting, via the group triggered mobility message, one or more indexes associated with the one or more second cell groups from among the plurality of cell groups, wherein each index of the one or more indexes indicates a respective candidate cell group for a respective UE of the plurality of UEs.

29. A method for wireless communication at a user equipment (UE), comprising:
receiving control signaling that indicates a plurality of cell groups and a plurality of cell group configurations, each cell group associated with a respective cell group configuration of the plurality of cell group configurations;
communicating via a first cell group of the plurality of cell groups in accordance with a first cell group configuration of the plurality of cell group configurations; and
receiving, via the first cell group, a group triggered mobility message that indicates for the UE and one or more second UEs to transition from the first cell group to one or more second cell groups of the plurality of cell groups, the one or more second cell groups associated with one or more second cell group configurations that are different than the first cell group configuration.

30. The method of claim 29, wherein receiving the group triggered mobility message comprises:
receiving, via the group triggered mobility message, an indication for the UE and the one or more second UEs to transition from the first cell group to a single candidate cell group of the plurality of cell groups.
